(19) United States
(12) Patent Application Publication
(10) Pub. No.: US 2025/0199889 A1
(43) Pub. Date: Jun. 19, 2025

(54) ALERT HANDLING NOTIFICATION METHOD, ALERT HANDLING NOTIFICATION DEVICE, AND RECORDING MEDIUM

(71) Applicant: Panasonic Intellectual Property Management Co., Ltd., Osaka (JP)

(72) Inventors: Rikiya HIRAISHI, Aichi (JP); Takuji HIRAMOTO, Osaka (JP); Tatsumi OBA, Chiba (JP)

(73) Assignee: Panasonic Intellectual Property Management Co., Ltd., Osaka (JP)

(21) Appl. No.: 19/067,108

(22) Filed: Feb. 28, 2025

Related U.S. Application Data
(63) Continuation of application No. PCT/JP2023/032258, filed on Sep. 4, 2023.

(30) Foreign Application Priority Data
Sep. 6, 2022 (JP) 2022-141185

(51) Int. Cl. G06F 9/54

(52) U.S. Cl. CPC G06F 9/542

(57) ABSTRACT

An alert handling notification method includes: receiving an alert indicating an anomaly in an Operational Technology environment; identifying a confirmation information item corresponding to a type of the alert, based on the alert and confirmation information items, each indicating content of a status confirmation for an alert of a corresponding type, and including a first item associated with a first weight and indicating a first status confirmation by a first handler, and a second item associated with a second weight and indicating a second status confirmation by a second handler; determining a handler to be preferentially caused to make a status confirmation for the alert, using the first and second weights specified based on the confirmation information item identified; notifying the first handler of the first item when the first handler is the handler; and notifying the second handler of the second item when the second handler is the handler.

### CROSS REFERENCE TO RELATED APPLICATIONS

This is a continuation application of PCT International Application No. PCT/JP2023/032258 filed on Sep. 4, 2023, designating the United States of America, which is based on and claims priority of Japanese Patent Application No. 2022-141185 filed on Sep. 6, 2022. The entire disclosures of the above-identified applications, including the specifications, drawings and claims are incorporated herein by reference in their entirety.

### FIELD

The present disclosure relates to an alert handling notification method, an alert handling notification device, and a recording medium for efficiently taking measures to handle an alert generated by a control system.

### BACKGROUND

Patent Literature (PTL) 1 discloses a method in which whether a detected alert is a security incident is determined, and the priority order of the incident is determined. Then, an operator of the IT system is not notified of incidents for which notifications need not be made, but is notified of incidents for which notifications need to be made, and the notification is made as an alert along with the priority order.

### CITATION LIST

### Patent Literature

PTL 1: Japanese Unexamined Patent Application Publication No. 2019-175070

### SUMMARY

### Technical Problem

The present disclosure provides an alert handling notification method and the like that can make a notification for efficiently taking measures to handle a detected alert.

### Solution to Problem

An alert handling notification method executed by an alert handling notification device according to one aspect of the present disclosure is an alert handling notification method including: receiving an alert indicating an anomaly that has occurred in an Operational Technology (OT) environment; identifying a confirmation information item corresponding to a type of the alert received, based on the alert and a plurality of confirmation information items stored in storage, the storage being included in the alert handling notification device, the plurality of confirmation information items each indicating content of a status confirmation for an alert of a type corresponding to the confirmation information item, and each including a first item associated with a first weight and indicating content of a first status confirmation made by a first handler, and a second item associated with a second weight and indicating content of a second status confirmation made by a second handler; determining a handler, among the first handler and the second handler, to be preferentially caused to make a status confirmation for the alert received, using the first weight and the second weight specified based on the confirmation information item identified; notifying the first handler of the first item when the first handler is determined to be the handler; and notifying the second handler of the second item when the second handler is determined to be the handler.

An alert handling notification device according to one aspect of the present disclosure includes: a communicator that receives an alert indicating an anomaly that has occurred in an Operational Technology (OT) environment; storage that stores a plurality of confirmation information items, each confirmation information item indicating content of a status confirmation for an alert of a type corresponding to the confirmation information item; and a determiner that determines a handler, among a first handler and a second handler, to be preferentially caused to make a status confirmation for the alert received. Each of the plurality of confirmation information items includes a first item associated with a first weight and indicating content of a first status confirmation made by the first handler, and a second item associated with a second weight and indicating content of a second status confirmation made by the second handler. The determiner determines the handler using the first weight and the second weight specified based on the confirmation information item corresponding to the type of the alert received. The communicator notifies the first handler of the first item when the first handler is determined to be the handler, and notifies the second handler of the second item when the second handler is determined to be the handler.

### Advantageous Effects

According to the alert handling notification device of the present disclosure, each handler can proceed with status confirmation for the alert for which the status confirmation is to be performed first, which makes it possible to streamline the status confirmations for alerts.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating the overall configuration of an alert handling system according to an embodiment.

FIG. 2 is a diagram illustrating the configuration of an alert handling notification device according to the embodiment.

FIG. 3 is a diagram illustrating a flowchart of handling priority calculation processing according to the embodiment.

FIG. 4 is a diagram illustrating alert information included in an alert according to the embodiment.

FIG. 5 is a diagram illustrating a flowchart of cause identification rate calculation processing according to the embodiment.

FIG. 6 is a diagram illustrating the configuration of each of detection models according to the embodiment.

FIG. 7 is a diagram illustrating an example of a confirmation item list of detection model A according to the embodiment.

FIG. 8 is a diagram illustrating an example of alert scores by severity according to the embodiment.

FIG. 9 is a diagram illustrating a calculation sequence and calculation results of handling priority calculation processing for a first alert according to the embodiment.

FIG. 10 is a diagram illustrating an example of administrator-focused output results up to the first alert according to the embodiment.

FIG. 11 is a diagram illustrating a calculation sequence and calculation results of handling priority calculation processing for a second alert according to the embodiment.

FIG. 12 is a diagram illustrating a calculation sequence and calculation results of handling priority calculation processing for a third alert according to the embodiment.

FIG. 13 is a diagram illustrating an example of administrator-focused output results up to the third alert according to the embodiment.

FIG. 14 is a diagram illustrating a flowchart of confirmation item input processing according to the embodiment.

FIG. 15 is a diagram illustrating an example of a UI display for inputting a confirmation result according to the embodiment.

FIG. 16 is a diagram illustrating the configuration of confirmed item storage and a confirmed item list according to the embodiment.

FIG. 17 is a diagram illustrating a flowchart of handling priority update processing according to the embodiment.

FIG. 18 is a diagram illustrating a flowchart of cause identification rate update processing according to the embodiment.

FIG. 19 is a diagram illustrating a handling priority calculation sequence and calculation results in first handling priority update processing in the embodiment.

FIG. 20 is a diagram illustrating an example of administrator-focused output results after the first handling priority update processing according to the embodiment.

FIG. 21 is a diagram illustrating a handling priority calculation sequence and calculation results in second handling priority update processing in the embodiment.

FIG. 22 is a diagram illustrating an example of analyst-focused output results after the second handling priority update processing according to the embodiment.

FIG. 23 is a diagram illustrating a flowchart of weight update processing according to the embodiment.

FIG. 24 is a diagram illustrating an example of weights in a confirmation item list being changed by the weight update processing according to the embodiment.

FIG. 25 is a diagram illustrating a flowchart of an alert handling notification method according to the embodiment.

FIG. 26 is a diagram illustrating a confirmation item list in which confirmation items are integrated, as a variation on the configuration of the confirmation item list.

FIG. 27 is a diagram illustrating a confirmation item list in which confirmation items are grouped, as a variation on the configuration of the confirmation item list.

FIG. 28 is a diagram illustrating an example of a bar format output as a variation on the UI display of the output results.

FIG. 29 is a diagram illustrating an example of a bar format output which is output along with a trajectory, as a variation on the UI display of the output results.

### DESCRIPTION OF EMBODIMENT

### Underlying Knowledge Forming Basis of Present Disclosure

Cyberattacks on control systems in factories, buildings, power systems, and the like have become more frequent and sophisticated in recent years, and security measures are now being taken against such cyberattacks. In addition to general measures such as Intrusion Prevention Systems (IPS) and Intrusion Detection Systems (IDS), there are also security measures that utilize the characteristics of the control system.

For example, in the network of a control system (“control network” hereinafter), the destination or content of communication by a managed device is static, and can therefore be ascertained in advance. Accordingly, anomaly detection used on the control network includes anomaly detection which utilizes a whitelist of communication pairs, anomaly detection which ascertains the behavior of devices from the communication content, and the like. A Security Operation Center (SOC) is an organization that analyzes alerts resulting from these anomaly detections to detect a cyberattack in a comprehensive manner. In an SOC, SOC analysis is performed to determine whether a cyberattack is underway by collecting and analyzing security alerts from a plurality of systems in an integrated monitoring system called Security Information and Event Management (SIEM).

Anomaly detection utilizing the characteristics of the control system detects advanced cyberattacks such as commands issued to control devices using legitimate protocols, unauthorized operations in control devices, and the like.

In this manner, as with Internet Technology (IT), cyberattacks are a constant risk in Operational Technology (OT) environments such as factories and buildings, and SIEM is therefore being introduced for security purposes. SIEM is expected to make it possible to capture indications of and detect cyberattacks at an early stage by collecting device logs, communication logs, and the like from the control system and centrally managing and analyzing such logs.

Specifically, a cyberattack is handled by constructing an SOC, detecting anomalies through SIEM, and then having an SOC analyst analyze alerts for which notifications have been made. The analyst analyzes whether an alert indicates a cyberattack, and if so, escalates the alert to a Security Incident Response Team (SIRT) to implement an incident response.

In an OT environment, communication pairs and communication protocols between devices are static, and these are defined in a whitelist. In SIEM, communication is monitored using this whitelist as rules for detecting anomalies, and communication other than that indicated in the whitelist is detected as an anomaly.

However, in the control system, when periodic device maintenance, unexpected maintenance jobs to handle device malfunctions or replace devices, or the like arise, or when an operator monitoring the operations of the control system intentionally performs a manual operation, the anomaly detection system may falsely detect such an event as an anomaly and issue an alert.

Therefore, when handling an alert provided through SIEM, it is necessary for the analyst to determine whether the alert is due to a cyberattack, or due to a false detection caused by device maintenance, an operation by an operator, or the like in the control system. When an alert is due to a cyberattack, the analyst can determine that the alert has been caused by the cyberattack by analyzing communication logs, control logs, and the like. On the other hand, when an alert is due to a false detection, maintenance performance information for control devices and the like at the site that produced the false detection is required to investigate the cause of the alert. However, at the point in time when the analysis is started, there is no information about the cause of the alert, and it is not possible to determine whether the alert is due to a cyberattack or a false detection. In other words, it is difficult to determine whether an alert is due to a cyberattack or a false detection unless an inquiry is made with an administrator or the like at the site and the administrator or the like performs a task for confirmation.

The past technique described above assumes that the analyst will handle all alerts in the determination of the priority order for handling the detected alerts, and does not consider selecting the handler preferentially depending on the type, content, or the like of the alert. For example, at the point in time when the analysis of an alert provided through SIEM is started, it is not possible to determine whether the alert is due to a cyberattack or a false detection. Accordingly, the analyst first performs the analysis within the scope they are capable of analyzing. An inquiry is only made to the administrator or the like of the site after the result of the analysis indicates that the detection may be a false detection, and the analysis is then performed again based on information obtained from the site. The analyst is therefore required to perform the analysis with insufficient information about the site, which is inefficient.

Therefore, to handle alerts efficiently, it is necessary to determine a preferred handler based on the type, content, and the like of the alert detected through SIEM.

To address the aforementioned issue, an alert handling notification method according to a first aspect of the present disclosure is an alert handling notification method executed by an alert handling notification device, the alert handling notification method including: receiving an alert indicating an anomaly that has occurred in an Operational Technology (OT) environment; identifying a confirmation information item corresponding to a type of the alert received, based on the alert and a plurality of confirmation information items stored in storage, the storage being included in the alert handling notification device, the plurality of confirmation information items each indicating content of a status confirmation for an alert of a type corresponding to the confirmation information item, and each including a first item associated with a first weight and indicating content of a first status confirmation made by a first handler, and a second item associated with a second weight and indicating content of a second status confirmation made by a second handler; determining a handler, among the first handler and the second handler, to be preferentially caused to make a status confirmation for the alert received, using the first weight and the second weight specified based on the confirmation information item identified; notifying the first handler of the first item when the first handler is determined to be the handler; and notifying the second handler of the second item when the second handler is determined to be the handler.

Through this, an appropriate handler can be determined for each alert, and the handler can be notified along with information for the status confirmation, making it possible to streamline the handling of the alerts.

An alert handling notification method according to a second aspect of the present disclosure is the alert handling notification method according to the first aspect, further including: notifying the second handler of the second item when first completion information indicating that the first handler has completed the first status confirmation is received; and notifying the first handler of the first item when second completion information indicating that the second handler has completed the second status confirmation is received.

Through this, when the status confirmation by one handler is completed for an alert, the other handler can immediately be notified of the content of the status confirmation the next time.

An alert handling notification method according to a third aspect of the present disclosure is the alert handling notification method according to the first aspect, wherein each of the plurality of confirmation information items further includes a third item associated with a third weight and indicating content of a third status confirmation made by the first handler, and a fourth item associated with a fourth weight and indicating content of a fourth status confirmation made by the second handler; the determining includes determining the handler using the first weight, the second weight, the third weight, and the fourth weight specified based on the confirmation information item corresponding to the type of the alert received; the notifying of the first item includes notifying the first handler of the first item and the third item in order from the item having a greater weight; and the notifying of the second item includes notifying the second handler of the second item and the fourth item in order from the item having a greater weight.

Through this, even if the content of the status confirmation performed by each handler for the alert includes a plurality of items, which of the first handler and the second handler is to perform the status confirmation for the alert first can be determined. In addition, the handler can be notified of the items for the status confirmation in order from the largest weight associated with each item, and the handler can proceed with the status confirmation efficiently.

An alert handling notification method according to a fourth aspect of the present disclosure is the alert handling notification method according to the third aspect, further including, when completion information indicating that one of the first status confirmation, the second status confirmation, the third status confirmation, or the fourth status confirmation is complete is received: redetermining the handler using one or more weights resulting from excluding, from the first weight, the second weight, the third weight, and the fourth weight, a weight associated with an item indicating content of a status confirmation indicated by the completion information as being complete; and notifying the handler of one or more items resulting from excluding, from the first item, the second item, the third item, and the fourth item, the item indicating the content of the status confirmation indicated by the completion information as being complete.

Through this, the determination for the handlers can be made dynamically according to the progress of the status confirmation for the alert, and the handlers can be notified in sequence.

An alert handling notification method according to a fifth aspect of the present disclosure is the alert handling notification method according to any one of the first to fourth aspects, wherein the first handler is an analyst who analyzes a cause of the alert, the second handler is an administrator who manages the Operational Technology (OT) environment, and the notifying of the second item further includes notifying the first handler that the second handler will make the status confirmation for the alert first.

Through this, the analyst can recognize when the administrator will perform the status confirmation for the issued alert first. In other words, the analyst can recognize the current situation even for an alert for which the analyst him/herself is not to perform the status confirmation first.

An alert handling notification method according to a sixth aspect of the present disclosure is the alert handling notification method according to the fifth aspect, wherein each of the plurality of confirmation information items further includes a third item associated with a third weight and indicating content of a third status confirmation made by the first handler, and a fourth item associated with a fourth weight and indicating content of a fourth status confirmation made by the second handler, and the alert handling notification method further comprises, when completion information indicating that the second status confirmation or the fourth status confirmation is complete is received: redetermining the handler using one weight resulting from excluding, from the second weight and the fourth weight, a weight associated with an item indicating content of a status confirmation indicated by the completion information as being complete; notifying the first handler of (i) the item indicating the content of the status confirmation indicated by the completion information as being complete and (ii) a confirmation result of the status confirmation; notifying the first handler of the first item when the first handler is determined to be the handler in the redetermining; and notifying the second handler of an item excluding the item indicating the content of the status confirmation indicated by the completion information as being complete, when the second handler is determined to be the handler in the redetermining.

Through this, the analyst can be notified of the item for which the status confirmation has been performed by the administrator, and the information on the site obtained as a result of the status confirmation for the item. Accordingly, the analyst can handle the alert by performing the status confirmation, analyzing the cause, and the like after obtaining the information on the site.

An alert handling notification method according to a seventh aspect of the present disclosure is the alert handling notification method according to the sixth aspect, further including: receiving, from the first handler, a true cause item indicating an item related to a cause of the alert; specifying an item indicated by the true cause item, among the first item, the second item, the third item, and the fourth item; and updating a weight associated with the item specified, to increase the weight.

Through this, when the same type of alert is issued and a notification is made the next or subsequent time, which of the first handler and the second handler should perform the status confirmation first can be determined using the updated weight. In other words, the determination can be made taking into account a history of handling of alerts that have occurred in the past, which makes it possible to handle the alert efficiently.

An alert handling notification method according to an eighth aspect of the present disclosure is the alert handling notification method according to the first aspect, wherein the determining includes: calculating a first priority indicating a degree of priority with which the first handler is to make the status confirmation for the alert, and a second priority indicating a degree of priority with which the second handler is to make the status confirmation for the alert, using the first weight and the second weight; determining the first handler to be the handler when the first priority is higher than the second priority; and determining the second handler to be the handler when the second priority is higher than the first priority.

An alert handling notification method according to a ninth aspect of the present disclosure is the alert handling notification method according to the eighth aspect, further including, when a plurality of alerts are received in the receiving: calculating the first priority for each of the plurality of alerts received, and determining a first priority order for making the status confirmation for each of the plurality of alerts in order from the alert for which the first priority is highest; calculating the second priority for each of the plurality of alerts received, and determining a second priority order for making the status confirmation for each of the plurality of alerts in order from the alert for which the second priority is highest; notifying the first handler of (i) the first priority order and (ii) the first item corresponding to an alert, among the plurality of alerts, that is highest in the first priority order; and notifying the second handler of (i) the second priority order and (ii) the second item corresponding to an alert, among the plurality of alerts, that is highest in the second priority order.

Through this, when a plurality of alerts are received, the priority order of the status confirmation for the first handler can be determined, and a notification can be made, by comparing the calculated plurality of first priorities. Likewise, the priority order of the status confirmation for the second handler can be determined, and a notification can be made, by comparing the calculated plurality of second priorities. Accordingly, each handler can understand the priority order of the status confirmation even when a plurality of alerts have been issued, and can efficiently proceed with the handling of the alerts.

An alert handling notification method according to a tenth aspect of the present disclosure is the alert handling notification method according to the eighth aspect, wherein when a plurality of alerts are received in the receiving, each of the plurality of alerts includes a severity indicating a magnitude of an impact of the alert, and the alert handling notification method further includes: calculating a third priority for each of the plurality of alerts received by multiplying the first priority by the severity of the alert, and determining a first priority order for making the status confirmation for each of the plurality of alerts in order from the alert for which the third priority is highest; calculating a fourth priority for each of the plurality of alerts received by multiplying the second priority by the severity of the alert, and determining a second priority order for making the status confirmation for each of the plurality of alerts in order from the alert for which the fourth priority is highest; notifying the first handler of (i) the first priority order and (ii) the first item corresponding to an alert, among the plurality of alerts, that is highest in the first priority order; and notifying the second handler of (i) the second priority order and (ii) the second item corresponding to an alert, among the plurality of alerts, that is highest in the second priority order.

Through this, the priority order of the status confirmation can be determined taking into account the severity of the alert. Accordingly, the priority order of a status confirmation for an alert having a high severity can be determined to be higher compared to an alert having a low severity, and because the status confirmation is prioritized by the handler, the impact of the alert can be suppressed as a result.

An alert handling notification method according to an eleventh aspect of the present disclosure is the alert handling notification method according to the eighth aspect, wherein each of the plurality of confirmation information items further includes a third item associated with a third weight and indicating content of a third status confirmation to be made by the first handler, and a fourth item associated with a fourth weight and indicating content of a fourth status confirmation to be made by the second handler, and the alert handling notification method further includes, when completion information indicating that one of the first status confirmation, the second status confirmation, the third status confirmation, or the fourth status confirmation is complete is received: recalculating the first priority and the second priority using one or more weights among the first weight, the second weight, the third weight, and the fourth weight, excluding a weight associated with an item indicating content of a status confirmation indicated by the completion information as being complete.

An alert handling notification method according to a twelfth aspect of the present disclosure is the alert handling notification method according to the tenth aspect, wherein each of the plurality of confirmation information items further includes a third item associated with a third weight and indicating content of a third status confirmation made by the first handler, and a fourth item associated with a fourth weight and indicating content of a fourth status confirmation made by the second handler, and the alert handling notification method further includes, when completion information indicating that one of the first status confirmation, the second status confirmation, the third status confirmation, or the fourth status confirmation is complete is received: recalculating the first priority and the second priority using one or more weights resulting from excluding, from the first weight, the second weight, the third weight, and the fourth weight, a weight associated with an item indicating content of a status confirmation indicated by the completion information as being complete; and recalculating the third priority and the fourth priority using the first priority and the second priority for the alert that have been recalculated.

Through this, the priority order of the status confirmation for the alert can be updated dynamically according to the progress of the status confirmation by the handler, which makes it possible to streamline the handling of the alerts as a whole.

A recording medium according to a thirteenth aspect of the present disclosure is a non-transitory computer-readable recording medium having recorded thereon a program for causing a computer to execute the alert handling notification method according to any one of the first to twelfth aspects.

An alert handling notification device according to a fourteenth aspect of the present disclosure is an alert handling notification device including: a communicator that receives an alert indicating an anomaly that has occurred in an Operational Technology (OT) environment; storage that stores a plurality of confirmation information items, each confirmation information item indicating content of a status confirmation for an alert of a type corresponding to the confirmation information item; and a determiner that determines a handler, among a first handler and a second handler, to be preferentially caused to make a status confirmation for the alert received. Each of the plurality of confirmation information items includes a first item associated with a first weight and indicating content of a first status confirmation made by the first handler, and a second item associated with a second weight and indicating content of a second status confirmation made by the second handler. The determiner determines the handler using the first weight and the second weight specified based on the confirmation information item corresponding to the type of the alert received. The communicator notifies the first handler of the first item when the first handler is determined to be the handler, and notifies the second handler of the second item when the second handler is determined to be the handler.

Through this, an appropriate handler can be determined for each alert, and the handler can be notified along with information for the status confirmation, making it possible to streamline the handling of the alerts.

The following embodiments describe specific examples of the present disclosure. The numerical values, shapes, constituent elements, steps, orders of steps, and the like in the following embodiments are merely examples, and are not intended to limit the present disclosure. Additionally, of the constituent elements in the following embodiments, constituent elements not denoted in the independent claims, which express the broadest interpretation, will be described as optional constituent elements. Additionally, in all of the embodiments and variations, individual details can be combined.

### Embodiment

An embodiment will be described hereinafter with reference to the drawings. Note that the same reference signs are used for the same constituent elements in the drawings.

### Overall Configuration

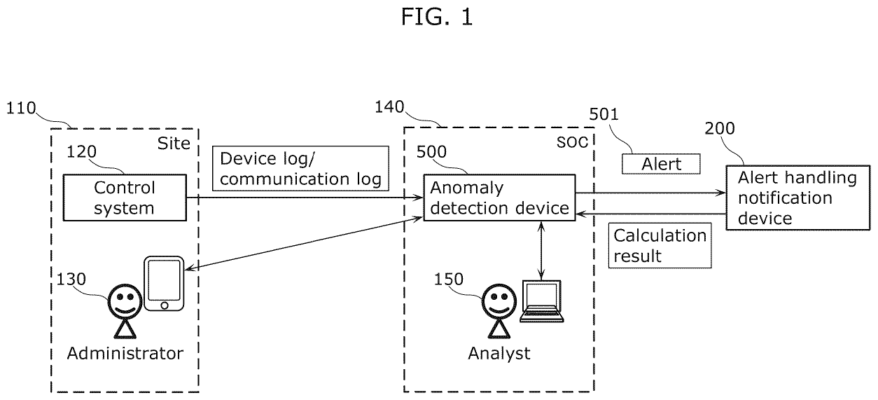

FIG. 1 is a diagram illustrating the overall configuration of an example of an alert handling system according to the present embodiment. In FIG. 1, the alert handling system includes control system 120, anomaly detection device 500, and alert handling notification device 200.

Control system 120 controls various devices, systems, and the like provided at site 110, which is an OT environment such as a factory or building. Control system 120 is communicably connected to anomaly detection device 500 over a communication network (not shown). The communication network may be the general Internet, or may be a dedicated communication line. In control system 120, anomaly detection device 500 may obtain log information including device logs and/or communication logs generated by control of various devices, systems, or the like provided at site 110, through mirroring over a communication network. Note that the log information may be sent over the communication network to anomaly detection device 500.

Note that control system 120 may be installed at site 110 as illustrated in FIG. 1, or outside site 110, as long as control system 120 can control the various devices, systems, and the like provided at site 110.

Anomaly detection device 500 collects the log information generated by control system 120, and detects an anomaly using the device logs, communication logs, and the like included in the collected log information.

Anomaly detection device 500 is capable of communicating with alert handling notification device 200 over the communication network, and when an anomaly is detected, alert handling notification device 200 is notified of alert 501 regarding the detected anomaly.

Note that anomaly detection device 500 may be installed in SOC 140 as illustrated in FIG. 1, or outside SOC 140, as long as anomaly detection device 500 can detect an anomaly based on the log information. Anomaly detection device 500 may be configured to include alert handling notification device 200.

Analyst 150 of SOC 140 analyzes the anomaly detected by anomaly detection device 500, such as through status confirmation, specifying a true cause, or the like for identifying the cause of alert 501 for which the notification was made. In addition, administrator 130 of site 110 performs a status confirmation for identifying the cause of alert 501 for which the notification was made. In the present embodiment, analyst 150 is an example of a first handler. Administrator 130 is an example of a second handler.

Alert handling notification device 200 calculates a cause identification rate indicating the likelihood that administrator 130 on the site 110 side and analyst 150 on the SOC 140 side can identify the cause of the generation of alert 501 for which the notification was made, calculates a handling priority indicating a priority order of alerts to be handled by each handler among at least one alert 501 for which the notification was made, and notifies anomaly detection device 500 of the calculation result.

Furthermore, alert handling notification device 200 receives a confirmation result for alert 501 from administrator 130 and analyst 150 via anomaly detection device 500.

When a confirmation result is input by administrator 130 or analyst 150 via anomaly detection device 500, alert handling notification device 200 notifies analyst 150 or administrator 130 of the confirmation result via anomaly detection device 500.

In addition, alert handling notification device 200 receives a true cause of alert 501 from administrator 130 or analyst 150 via anomaly detection device 500.

Administrator 130 and analyst 150 communicate with anomaly detection device 500 over an information communication network using an information terminal such as a personal computer, a tablet, or the like. That is, anomaly detection device 500 may accept information indicating an input made by administrator 130 or information indicating an input made by analyst 150 from an information terminal that accepts inputs from administrator 130 or from an information terminal that accepts inputs from analyst 150. Note that analyst 150 may directly operate anomaly detection device 500 without using an information terminal. In other words, anomaly detection device 500 may directly accept inputs from analyst 150.

Note that administrator 130 and analyst 150 may communicate with alert handling notification device 200 without going through anomaly detection device 500.

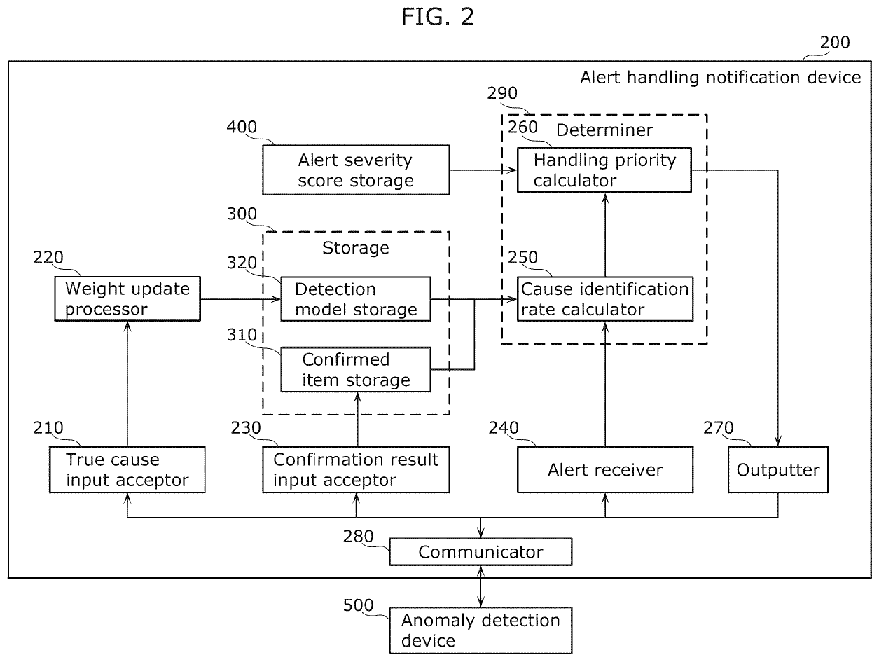

FIG. 2 is a diagram illustrating the overall configuration of alert handling notification device 200 according to the present embodiment. In FIG. 2, alert handling notification device 200 includes true cause input acceptor 210, weight update processor 220, confirmation result input acceptor 230, alert receiver 240, cause identification rate calculator 250, handling priority calculator 260, outputter 270, communicator 280, alert severity score storage 400, and storage 300.

Alert severity score storage 400 stores an alert score for a severity assigned to alert 501.

Storage 300 includes detection model storage 320 and confirmed item storage 310.

Detection model storage 320 stores a plurality of detection models corresponding to names of alerts 501. The name of alert 501 corresponds to a type of the alert. The detection model corresponding to the name of alert 501 includes a site-side confirmation item list, which includes a plurality of items indicating the content of status confirmations performed by administrator 130 for alert 501, and an SOC-side confirmation item list, which includes a plurality of items indicating the content of status confirmations performed by analyst 150 for alert 501.

In the present embodiment, the plurality of items included in the SOC-side confirmation item list, which indicates items to be confirmed by analyst 150 for alert 501, are examples of a first item and a third item. The plurality of items included in the site-side confirmation item list, which indicates items to be confirmed by administrator 130 for alert 501, are examples of a second item and a fourth item.

Confirmed item storage 310 stores a site-side confirmed item list, which indicates confirmed items that are items, among the confirmation items included in the confirmation item list, that have been confirmed by administrator 130 for alert 501, and an SOC-side confirmed item list, which indicates confirmed items that are items, among the confirmation items included in the confirmation item list, that have been confirmed by analyst 150 for alert 501. These confirmed item lists are stored for each alert 501.

Communicator 280 communicates with anomaly detection device 500.

Alert receiver 240 receives alert 501, for which a notification was made by anomaly detection device 500, from communicator 280. Determiner 290 includes cause identification rate calculator 250 and handling priority calculator 260.

Cause identification rate calculator 250 obtains alert 501 received by alert receiver 240 and identifies, from among the plurality of detection models stored in detection model storage 320, a detection model corresponding to the name of the alert included in alert 501.

Cause identification rate calculator 250 obtains the site-side confirmation item list for administrator 130 and the SOC-side confirmation item list for analyst 150, stored in the identified detection model, from detection model storage 320, and calculates a site-side cause identification rate and an SOC-side cause identification rate for alert 501 using the confirmation items in the obtained confirmation item lists.

The cause identification rate is a degree that indicates the likelihood of identifying the cause of the alert on both the site 110 side and the SOC 140 side when handling alert 501 (status confirmation). The site-side cause identification rate is calculated based on the site-side confirmation item list for administrator 130, and the SOC-side cause identification rate is calculated based on the SOC-side confirmation item list for SOC 140.

In the present embodiment, the SOC-side cause identification rate is an example of a first priority, and the site-side cause identification rate is an example of a second priority.

Handling priority calculator 260 obtains the alert score for the severity included in alert 501 from alert severity score storage 400. Handling priority calculator 260 calculates a site-side handling priority and an SOC-side handling priority using the obtained alert score of the severity, and the site-side cause identification rate and SOC-side cause identification rate calculated by cause identification rate calculator 250. Specifically, the site-side handling priority is calculated by multiplying the site-side cause identification rate and the alert score for the severity. The SOC-side handling priority is calculated by multiplying the SOC-side cause identification rate and the alert score for the severity.

Handling priority calculator 260 notifies outputter 270 of the calculated site-side handling priority and SOC-side handling priority. “Handling priority” indicates a priority order for alerts to be handled among at least one alert 501 for which the cause is to be analyzed. The site-side handling priority is a priority order for alerts to be handled on the site 110 side (i.e., alerts to be handled by administrator 130), and the SOC-side handling priority is a priority order for alerts to be handled on the SOC 140 side (i.e., alerts to be handled by analyst 150).

In the present embodiment, the SOC-side handling priority is an example of a third priority, and the site-side handling priority is an example of a fourth priority.

Outputter 270 outputs the site-side handling priority and SOC-side handling priority for which the notifications have been made. By outputting information including the site-side handling priority and the SOC-side handling priority to at least one of anomaly detection device 500, the information terminal of analyst 150, and the information terminal of administrator 130 via communicator 280, outputter 270 may display the site-side handling priority and the SOC-side handling priority in a user interface (UI) of those devices or terminals; or, each handler may be notified of the information using a tool such as email.

Confirmation result input acceptor 230 accepts, from the information terminal of administrator 130 or the information terminal of analyst 150 via anomaly detection device 500, a result of confirming a confirmation item in the confirmation item list for alert 501 from communicator 280. The accepted result is stored in confirmed item storage 310 for each alert.

True cause input acceptor 210 accepts, from the information terminal of analyst 150 via anomaly detection device 500, the input of a true cause as an analysis result for alert 501 from communicator 280. True cause input acceptor 210 notifies weight update processor 220 of the input true cause.

Weight update processor 220 updates weights in the confirmation item list of the corresponding detection model stored in detection model storage 320 using the true cause for which the notification was made.

### Operations

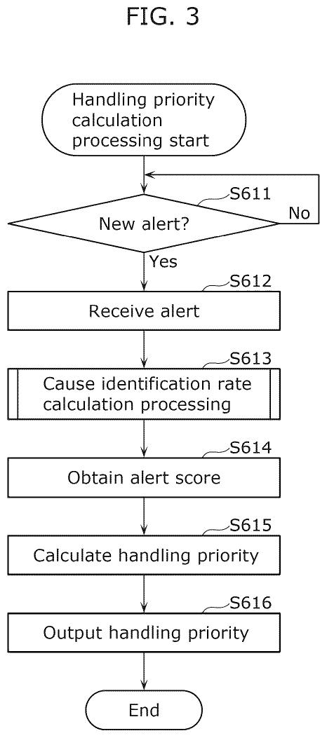

FIG. 3 is a flowchart illustrating handling priority calculation processing by alert handling notification device 200 according to the present embodiment.

(S611) Alert receiver 240 determines whether a notification of a new alert 501 has been made by anomaly detection device 500 via communicator 280. If a notification of a new alert 501 has been made (YES in step S611), alert handling notification device 200 performs the processing of step S612, whereas if a notification of a new alert 501 has not been made (NO in step S611), alert handling notification device 200 returns to the processing of step S611.

(S612) Alert receiver 240 receives alert 501 for which the notification was made.

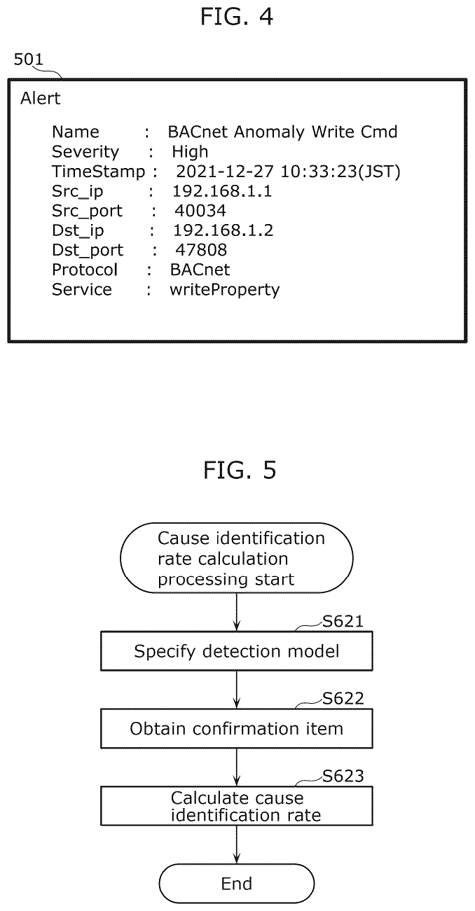

Alert 501 will be described in detail here. FIG. 4 is a diagram illustrating an example of alerts according to the present embodiment. In FIG. 4, alert 501 includes Name, Severity, TimeStamp, Src_ip, Src_port, Dst_ip, Dst_port, Protocol, and Service.

“Name” indicates the name of the alert. “Severity” indicates the severity of alert 501. “TimeStamp” indicates the time when the anomaly of alert 501 was detected. “Src_ip” indicates a source IP address of the communication in which the anomaly was detected. “Src_port” indicates a source port number of the communication in which the anomaly was detected. “Dst_ip” indicates a destination IP address of the communication in which the anomaly was detected. “Dst_port” indicates a destination port number of the communication in which the anomaly was detected. “Protocol” indicates the transmission protocol of the communication in which the anomaly was detected. “Service” indicates the service details of the communication in which the anomaly was detected.

In FIG. 4, alert 501 indicates that an anomaly for which the name of the alert is “BACnet Anomaly Write Cmd” was detected at time “2021 Dec. 27 10:33:23”, with a severity of “High”.

Note that it is sufficient for alert 501 to include at least “Name” and “Severity”.

The descriptions will return to the handling priority calculation processing illustrated in FIG. 3.

(S613) To identify the received alert 501, cause identification rate calculator 250 assigns an identification number of 1, 2, 3, and 4 in the order in which the alerts are received. In other words, the identification number may indicate the order in which the alert was received.

Cause identification rate calculator 250 performs cause identification rate calculation processing using the received alert 501. In addition, cause identification rate calculator 250 notifies handling priority calculator 260 of the site-side cause identification rate and the SOC-side cause identification rate for alert 501 calculated through the cause identification rate calculation processing.

The cause identification rate calculation processing of step S613 will be described in detail here. FIG. 5 is a flowchart of the cause identification rate calculation processing according to the present embodiment.

(S621) Cause identification rate calculator 250 identifies a detection model that matches the Name of the received alert 501.

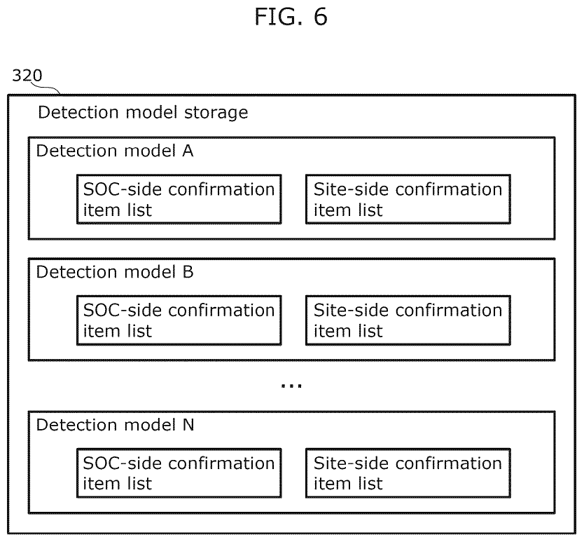

The detection models will be described in detail here. FIG. 6 is a diagram illustrating an example of the detection models according to the present embodiment. In FIG. 6, the detection models include detection model A, detection model B, and so on up to detection model N, and each detection model is stored in detection model storage 320. Each detection model corresponds to a Name (i.e., a type) of alert 501, and includes an SOC-side confirmation item list and a site-side confirmation item list, respectively. The SOC-side confirmation item list is a list of items confirmed by analyst 150. The site-side confirmation item list is a list of items confirmed by administrator 130. Each of the SOC-side confirmation item list and the site-side confirmation item list includes at least one item.

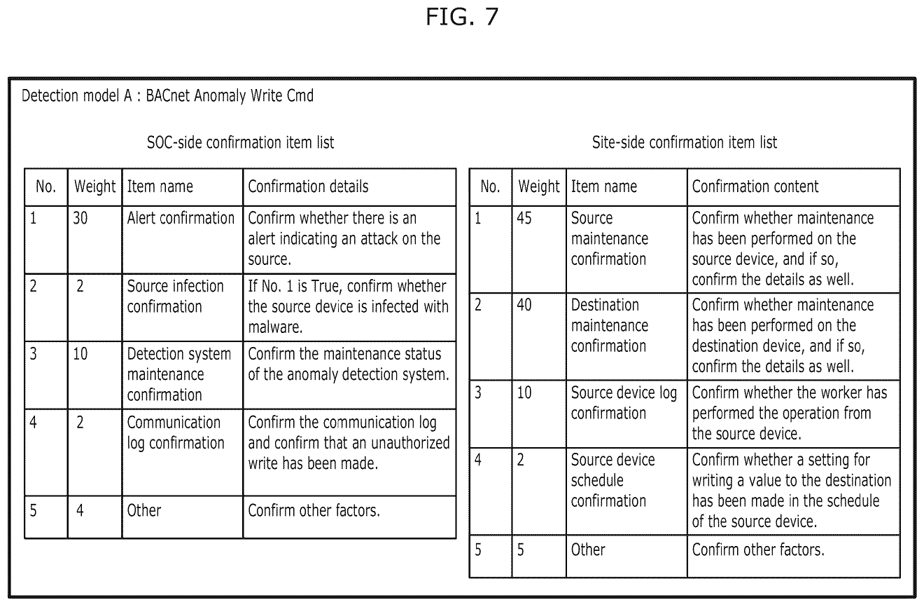

FIG. 7 is a diagram illustrating an example of detection model A according to the present embodiment. In FIG. 7, detection model A corresponds to the Name “BACnet Anomaly Write Cmd” of alert 501.

Each of the SOC-side confirmation item list and the site-side confirmation item list includes an item number (No.), an item name, confirmation content, and a weight.

The item name and confirmation content indicate the item to be confirmed by administrator 130 or analyst 150, and the content corresponding to the item, respectively.

For example, in FIG. 7, No. 1 in the site-side confirmation item list includes a weight of “45”, an item name of “source maintenance confirmation”, and confirmation content of “confirm whether maintenance has been performed on the source device, and if so, confirm the details as well”.

The weight is a degree indicating how likely the item is to be a factor in issuing the alert, obtained from a history of past analysis results, and is associated with each item. The weight can take on a value of at least 1. For example, in the site-side confirmation item list in FIG. 7, a weight of “45” is associated with item No. 1, a weight of “40” is associated with item No. 2, and a weight of “10” is associated with item No. 3. Administrator 130 or analyst 150 performs the confirmation in order from the confirmation item for which the weight of the item has the highest value.

The descriptions of the present embodiment will continue according to an example in which the first alert 501 for which a notification is made is an alert for which the Name in FIG. 4 is “BACnet Anomaly Write Cmd”, and the detection model is detection model A illustrated in FIG. 7. Cause identification rate calculator 250 identifies “detection model A” as the detection model corresponding to the alert based on the Name of the alert.

The descriptions will return to the cause identification rate calculation processing illustrated in FIG. 5.

(S622) Cause identification rate calculator 250 obtains the SOC-side confirmation item list and the site-side confirmation item list included in the specified detection model A illustrated in FIG. 7.

(S623) Cause identification rate calculator 250 calculates the site-side cause identification rate and the SOC-side cause identification rate of the first alert 501 for which the notification was made, using the weight in the obtained site-side confirmation item list and the weight in the SOC-side confirmation item list. The site-side cause identification rate is calculated through Formula 1, and the SOC-side cause identification rate is calculated through Formula 2.

$$\begin{matrix}[ Math 1 ] & \\ Site - side cause identification rate = \frac{( Sum of weights of site - side confirmation items )}{\begin{matrix}\{ ( Sum of weights of SOC - side confirmation items ) + \\ ( Sum of weights of site - side confirmation items ) \}\end{matrix}} & ( Formula 1 )\end{matrix}$$

$$\begin{matrix}[ Math 2 ] & \\ SOC - side cause identification rate = \frac{( Sum of weights of SOC - side confirmation items )}{\begin{matrix}\{ ( Sum of weights of SOC - side confirmation items ) + \\ ( Sum of weights of site - side confirmation items ) \}\end{matrix}} & ( Formula 2 )\end{matrix}$$

The sum of the weights of the site-side confirmation items is obtained by totaling the plurality of weights associated with corresponding ones of the plurality of items included in the site-side confirmation item list. The plurality of weights associated with the corresponding ones of the plurality of items included in the site-side confirmation item list are examples of a second weight and a fourth weight. Similarly, the sum of the weights of the SOC-side confirmation items is obtained by totaling the plurality of weights associated with corresponding ones of the plurality of items included in the SOC-side confirmation item list. The plurality of weights associated with the corresponding ones of the plurality of items included in the SOC-side confirmation item list are examples of a first weight and a third weight.

The weights of the confirmation items in the site-side confirmation item list of detection model A are, in order, 45, 40, 10, 2, and 5, and the total weight of the site-side confirmation items is therefore 102. The weights of the confirmation items in the SOC-side confirmation item list of detection model A are, in order, 30, 2, 10, 2, and 4, and the total weight of the SOC-side confirmation items is therefore 48.

According to Formula 1, the site-side cause identification rate is 102/(48+102)=0.68, calculated as 68%, and according to Formula 2, the SOC-side cause identification rate is 48/(48+102)=0.32, calculated as 32%.

The descriptions will return to the handling priority calculation processing illustrated in FIG. 3.

(S614) Handling priority calculator 260 obtains the alert score corresponding to the severity included in alert 501 from alert severity score storage 400.

The alert score will be described in detail here.

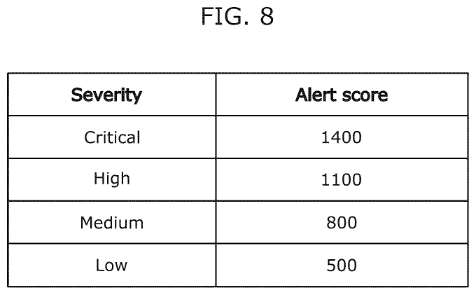

FIG. 8 is a diagram illustrating an example of the correspondence between the alert severity and the alert score, stored in alert severity score storage 400. The alert score indicates the severity of the alert as a numerical value, and a higher numerical value is set for a higher alert severity.

In FIG. 8, there are four types of severity, namely “Critical”, “High”, “Medium”, and “Low”, in order from the highest severity, and each represents the magnitude of the impact of alert 501 for which the notification was made.

In FIG. 8, the alert score for which the severity is “Critical” is “1400”, the alert score for “High” is “1100”, the alert score for “Medium” is “800”, and the alert score for “Low” is “500”.

Since the severity of the first alert 501 for which a notification was made is “High”, handling priority calculator 260 obtains the alert score of “1100”, which is the alert score for “High”, from alert severity score storage 400.

Note that the severity is not limited to four types, and the alert scores corresponding to the severities are not limited to those described above, as long as a higher value is set for a greater degree indicating the magnitude of the effect of alert 501 indicated by the severity.

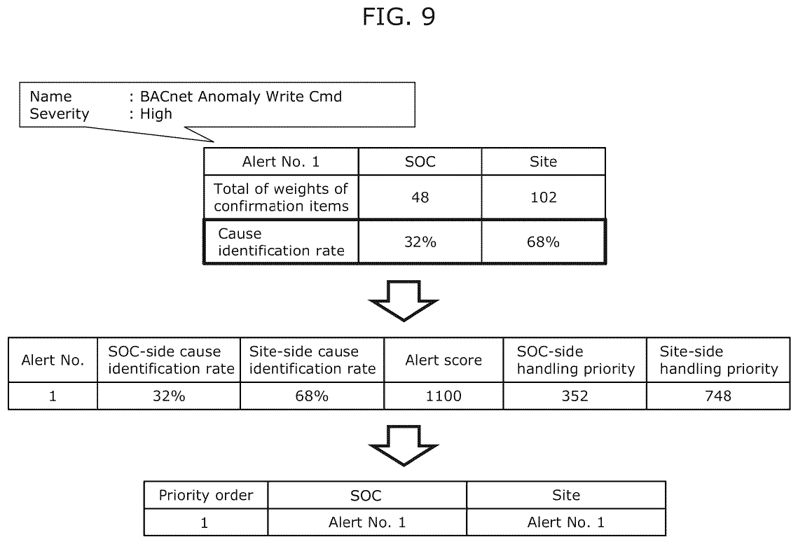

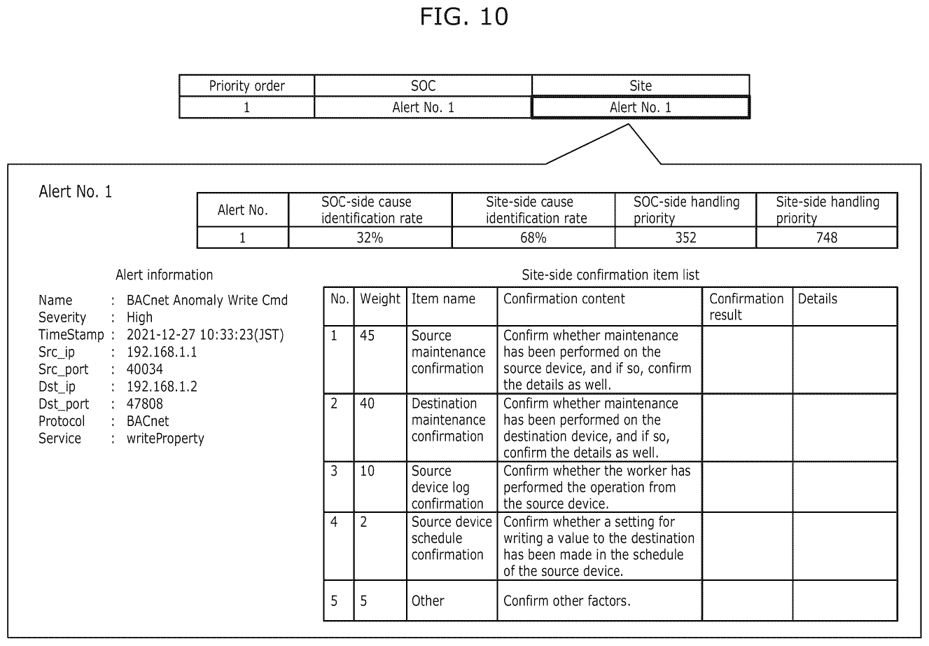

(S615) Handling priority calculator 260 calculates the site-side handling priority and SOC-side handling priority using the site-side cause identification rate and SOC-side cause identification rate calculated and the alert score obtained. FIG. 9 is a diagram illustrating a calculation sequence and calculation results of the handling priority calculation processing for the first alert according to the present embodiment. The site-side handling priority is calculated through Formula 3, and the SOC-side handling priority is calculated through Formula 4.

[Math 3]

Site-side handling priority=Site-side cause identification rate×Alert score (Formula 3)

[Math 4]

SOC-side handling priority=SOC-side cause identification rate×Alert score (Formula 4)

The site-side handling priority is calculated as 0.68×1100=748 through Formula 3, and the SOC-side handling priority is calculated as 0.32×1100=352 through Formula 4. Since a notification was made for one alert 501, the handling by administrator 130 of site 110 is first in the priority order, and the handling by analyst 150 of SOC 140 is also first in the priority order.

Here, if alert 501 for which the notification was made is only the one first alert, both the priority order for prioritizing the handling by administrator 130 (i.e., the status confirmation) and the priority order for prioritizing the handling by analyst 150 (i.e., the status confirmation) are both the first alert. In such a case, the site-side handling priority corresponding to the alert highest in the priority order is compared with the SOC-side handling priority, and it is determined that the handling should be performed from the higher thereof. For example, because the site-side handling priority for the first alert in the present embodiment is 748, and the SOC-side handling priority is 352, it is determined that administrator 130 on the site side, who has a higher handling priority, should perform the handling of the first alert first. In other words, of administrator 130 and analyst 150, the handler who is to make the status confirmation for the alert preferentially is determined using the site-side handling priority and the SOC-side handling priority. Note that if the alert is the same, the alert score will also be the same value, and thus the stated comparison may be made by comparing the site-side cause identification rate and the SOC-side cause identification rate.

Handling priority calculator 260 notifies outputter 270 of the site-side handling priority and SOC-side handling priority calculated, and the priority orders of the handling by administrator 130 and analyst 150.

(S616) Outputter 270 outputs the handling priority calculated in step S615 and the priority order of the alert handling, and ends the handling priority calculation processing. The output result is displayed in a UI of at least one of anomaly detection device 500, the information terminal of analyst 150, and the information terminal of administrator 130, via communicator 280. At least one of administrator 130 and analyst 150 is notified of the output result through the UI display. Note that administrator 130 and analyst 150 may be notified of the output result by a tool such as email directly from outputter 270.

As described above, in the present embodiment, the handler to perform the status confirmation first for the first alert is determined to be administrator 130 on the site 110 side as described above, and thus administrator 130 is notified of the output result.

Note that if it is determined that administrator 130 is to be notified of the output result, analyst 150 may be notified of information indicating that administrator 130 will perform the status confirmation for the first alert first. This enables analyst 150 to recognize that administrator 130 will perform the status confirmation for the first alert first, even if analyst 150 him/herself will not perform the status confirmation for the first alert first.

In addition to the calculation sequence and the calculation result in the handling priority calculation processing illustrated in FIG. 9, the output result includes the alert information of alert 501 illustrated in FIG. 4, the content of the confirmation item list illustrated in FIG. 7 corresponding to the alert, and the like. Additionally, the content included in the output result may change according to the output destination. For example, the site-side confirmation item list may be output when outputting to administrator 130, and both the site-side confirmation item list and the SOC-side confirmation item list may be output when outputting to analyst 150. In addition, the output result may be output in JSON format, such as {Site Possible Cause: 0.68, SOC Possible Cause: 0.32, Site Priority Value: 748, SOC Priority Value: 352}.

FIG. 10 illustrates the output result of which administrator 130 is notified as an example of the output. In FIG. 10, the priority order for the alert handling is indicated first. Next, the result of calculating the cause identification rate and the handling priority for the first alert, the alert information, and the site-side confirmation item list for the alert are indicated, as the alert first in the priority order on the site side.

In addition, the confirmation result at the time of notification and the details thereof are indicated for each confirmation item in the site-side confirmation item list. At the time when administrator 130 is first notified of the output result, the confirmation item has not yet been confirmed, and therefore nothing is written in the confirmation result and the details thereof. Note that FIG. 10 indicates an output result of which administrator 130 is notified, and therefore does not illustrate the SOC-side confirmation item list.

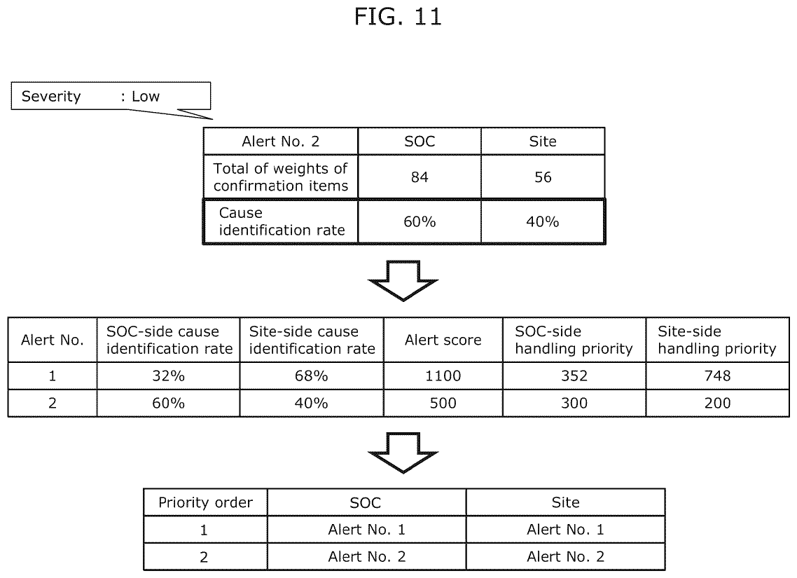

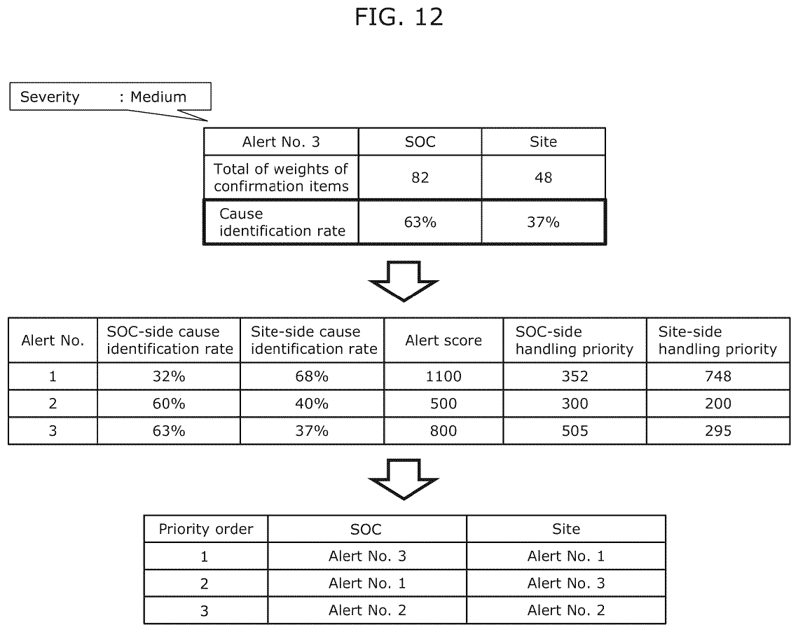

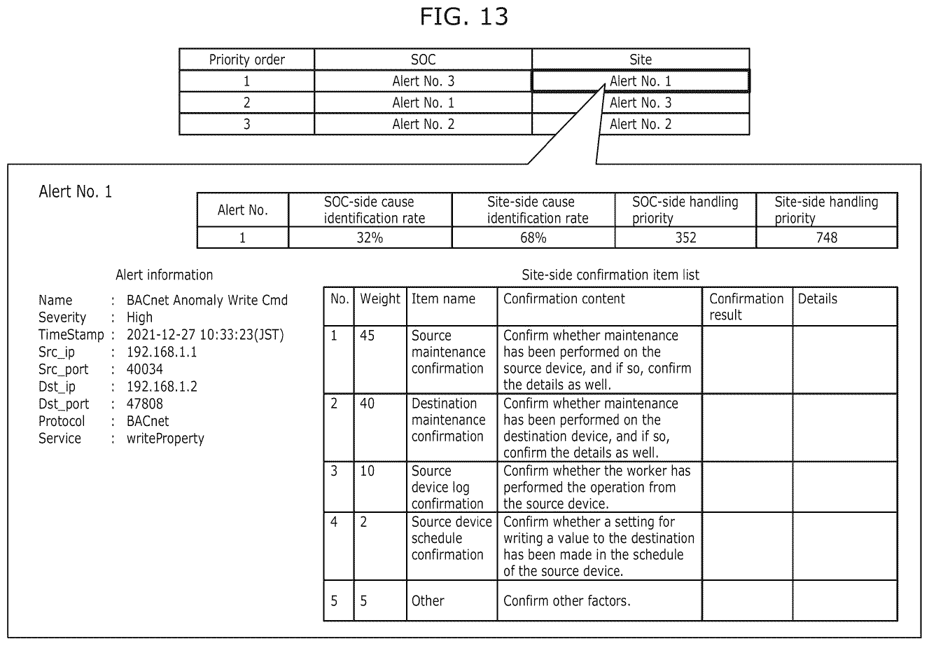

Next, the handling priority calculation processing performed when notifications are subsequently made for second and third alerts 501 after the first alert 501 will be described with reference to FIGS. 11 and 12. FIG. 11 is a diagram illustrating a calculation sequence and calculation results of the handling priority calculation processing for the second alert according to the present embodiment. FIG. 12 is a diagram illustrating a calculation sequence and calculation results of the handling priority calculation processing for the third alert according to the present embodiment.

In FIG. 11, the severity of the second alert is “Low” and the alert score is “500”, the total weight of the site-side confirmation item list in the corresponding detection model is “56”, and the total weight of the SOC-side confirmation item list is “84”.

The site-side cause identification rate is 56/(84+56)=0.4, calculated as 40%, and the SOC-side cause identification rate is 84/(84+56)=0.6, calculated as 60%.

The site-side handling priority is calculated as 0.4×500=200, and the SOC-side handling priority is calculated as 0.6×500=300.

Accordingly, the priority order for the handling by administrator 130 of site 110 is the first alert and the second alert. The priority order for the handling by analyst 150 is the first alert and the second alert.

In FIG. 12, the severity of the third alert is “Medium” and the alert score is “800”, the total weight of the site-side confirmation item list in the corresponding detection model is “82”, and the total weight of the SOC-side confirmation item list is “48”.

The site-side cause identification rate is 82/(48+82)=0.631 . . . , calculated as 63%, and the SOC-side cause identification rate is 48/(48+82)=0.369 . . . , calculated as 37%.

The site-side handling priority is calculated as 0.63×800=505, and the SOC-side handling priority is calculated as 0.37×800=295.

Accordingly, the priority order for the handling by administrator 130 of site 110 is the first alert, the third alert, and the second alert, and the priority order for the handling by analyst 150 of SOC 140 is the third alert, the first alert, and the second alert.

As when there is one alert 501 for which a notification was made, administrator 130 and analyst 150 are notified of the calculation results by displaying the calculation results in a UI of at least one of anomaly detection device 500, the information terminal of analyst 150, and the information terminal of administrator 130, via communicator 280 from outputter 270. In addition to the result of calculating the cause identification rate and the handling priority for the specific alert, the alert information, the confirmation item list for the alert, and the like are output to administrator 130 and analyst 150.

Here, the output results of which administrator 130 and analyst 150 are notified are at least for the alert highest in the priority order for each. In the present embodiment, the result of calculating the cause identification rate and the handling priority for the first alert, the site-side confirmation item list, and the like are output to administrator 130. The result of calculating the cause identification rate and the handling priority for the third alert, the SOC-side confirmation item list, and the like are output to analyst 150.

FIG. 13 illustrates the output result of which administrator 130 is notified as an example of the output after the notification of the third alert is made and the handling priority is calculated. In FIG. 13, the priority order for the alert handling is indicated first. Next, the result of calculating the cause identification rate and the handling priority for the first alert, the alert information, and the site-side confirmation item list for the alert are indicated, as the alert first in the priority order on the site side. In addition, the confirmation result at the time the output was made and the details thereof are indicated for each confirmation item in the site-side confirmation item list. Note that at the time when the output indicated in FIG. 13 is made in the present embodiment, the confirmation item has not yet been confirmed, and therefore nothing is written in the confirmation result and the details thereof.

Confirming Confirmation Items and Updating Handling priority

In the present embodiment, in the state where the handling priorities for up to the third alert are calculated and the calculation results are output, analyst 150 of SOC 140 is notified to start the handling from the third alert, and administrator 130 of site 110 is notified to start the handling from the first alert, as illustrated in FIG. 12.

In other words, administrator 130 and analyst 150 each can confirm the confirmation items listed in the confirmation item list corresponding to the alert from the alert highest in the priority order. The status confirmation is performed in order from the item having the highest weight associated with the corresponding confirmation item.

For example, administrator 130 is notified that the handling is to be performed from the first alert, and is also notified of the alert information and the site-side confirmation item list, as illustrated in FIG. 13. Here, administrator 130 first confirms the confirmation content of item No. 1, that is, “source maintenance confirmation”, which is the confirmation item having the highest weight in the site-side confirmation item list in the first alert. The confirmation content is “confirm whether maintenance has been performed on the source device, and if so, confirm the details as well”.

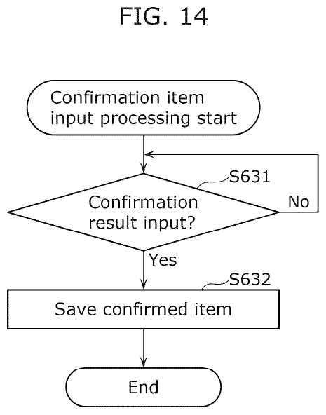

The confirmation item input processing performed by alert handling notification device 200 will be described next. FIG. 14 is a flowchart illustrating the confirmation item input processing.

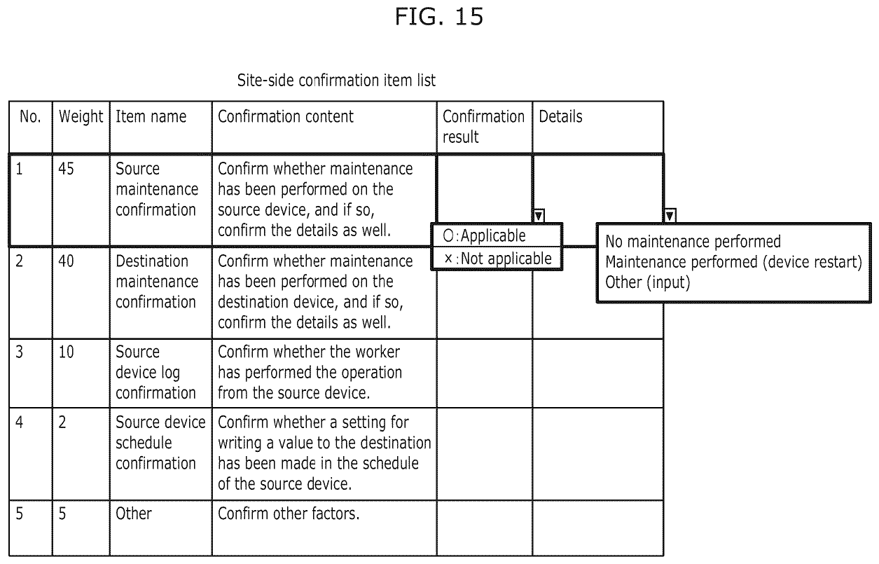

(S631) Alert handling notification device 200 stands by until the confirmation item is configured by administrator 130 and analyst 150 and the confirmation results are input to confirmation result input acceptor 230, and once the confirmation result is input, performs the processing of step S632. Here, the input of the confirmation result is performed by making an input to the UI displayed in the information terminal of administrator 130 or analyst 150, making a direct input to the UI of anomaly detection device 500, or the like, and the input information is input to confirmation result input acceptor 230 via anomaly detection device 500 and communicator 280. FIG. 15 illustrates an example of the UI used for input.

FIG. 15 illustrates a UI displayed in the information terminal of administrator 130 and used by administrator 130 to input the confirmation result. The site-side confirmation item list, the confirmation result for each item in the site-side confirmation item list, and an input field for the details thereof, are displayed.

In FIG. 15, content can be input to the confirmation result column and the details column for each item by administrator 130. For example, when administrator 130 confirms the confirmation item, if an event corresponding to the confirmation content is observed, “a circle mark: applicable” is input to the confirmation result field, and if the corresponding event is not observed, “x: not applicable” is input to the confirmation result field. In addition, the reason for and circumstances of the confirmation result are input into the details field. For example, confirmation result details such as “no maintenance performed”, “maintenance performed (device restart)”, and “other” are input.

The inputs into the confirmation result field and the details field may be made in a format selected from among items set in advance, or may be made in a format in which a character string indicating an item set in advance is entered through an input device such as an information terminal.

The UI in FIG. 15 is included in the UI of the output result displayed to administrator 130, illustrated in FIG. 13. In other words, the display of the output result and the input of the confirmation result are performed through the same UI. Note that the UI illustrated in FIG. 15 may be output to anomaly detection device 500 independent of the display of the output result, and the input may be accepted through the UI, or through a tool such as email.

FIGS. 13 and 15 illustrate a UI displayed for administrator 130, but in the UI displayed for analyst 150, the SOC-side confirmation item list is displayed instead of the site-side confirmation item list, and a UI for inputting the confirmation result of the SOC-side confirmation item list is included. As with administrator 130, if analyst 150 confirms the confirmation item, the confirmation result is input through the stated UI.

The descriptions of the present embodiment will continue for a case where administrator 130 confirms the confirmation item, “x: not applicable” is input to the confirmation result for the item No. 1, and “no maintenance performed” is input in the details.

(S632) Confirmed item storage 310 stores the confirmed confirmation item input to confirmation result input acceptor 230 as a confirmed item.

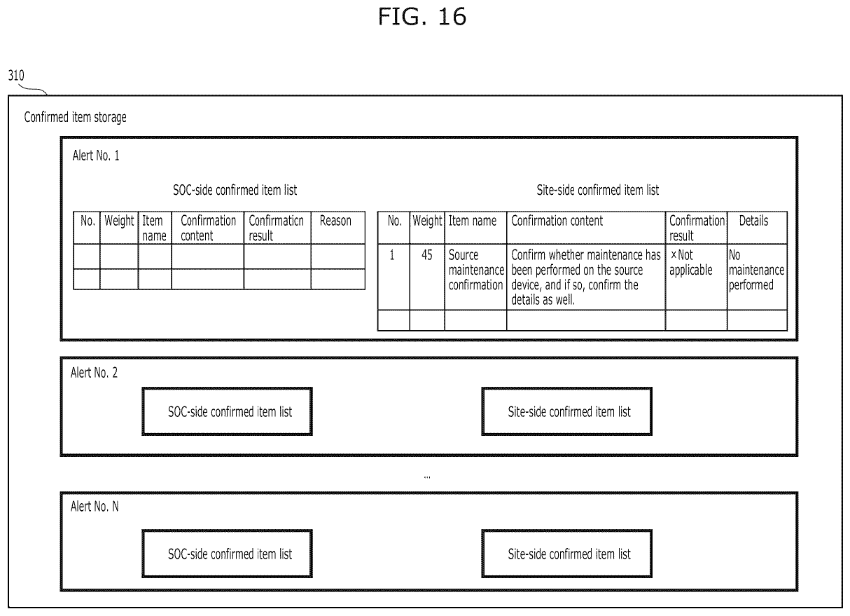

The confirmed item will be described in detail here. FIG. 16 is a diagram illustrating an example of confirmed items according to the present embodiment. In FIG. 16, confirmed items are stored individually for each alert, and confirmed items for the first alert, the second alert, and the N-th alert are stored in confirmed item storage 310. The confirmed items for one alert include both an SOC-side confirmed item list and a site-side confirmed item list. The SOC-side confirmed item list includes items that have been confirmed by analyst 150. The site-side confirmed item list includes items that have been confirmed by administrator 130. The confirmed item list is updated when the confirmation results for the confirmation items are input to confirmation result input acceptor 230. In FIG. 16, the confirmation item for No. 1, input as a confirmed item by administrator 130, is stored in the site-side confirmed item list.

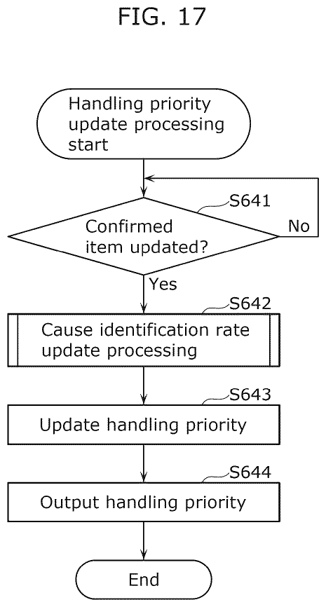

Handling priority update processing performed by alert handling notification device 200 will be described next. FIG. 17 is a flowchart of the handling priority update processing according to the embodiment.

(S641) After the confirmation items are confirmed by administrator 130 or analyst 150, alert handling notification device 200 stands by until the confirmed items are updated through step S632 of the confirmation item input processing. If the confirmed items are updated, the processing of step S642 is performed.

(S642) Cause identification rate calculator 250 performs the cause identification rate calculation processing for alert 501 for which the confirmed items have been updated as a result of the confirmation item input processing. In addition, cause identification rate calculator 250 notifies handling priority calculator 260 of the site-side cause identification rate and the SOC-side cause identification rate for alert 501 updated through the cause identification rate update processing.

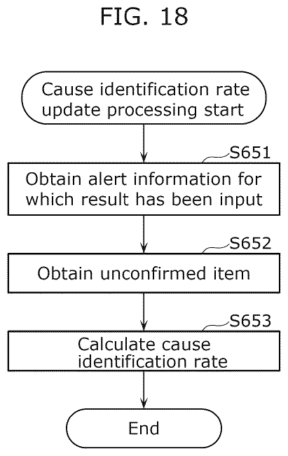

The cause identification rate update processing of step S642 will be described in detail here. FIG. 18 is a flowchart of the cause identification rate calculation processing according to the present embodiment.

(S651) Cause identification rate calculator 250 obtains the alert No. and the detection model as information on the alert for which the confirmation results were input as a result of the confirmation item input processing. In the present embodiment, cause identification rate calculator 250 obtains information indicating that the alert is the first alert, i.e., an alert No. of “1”, and that the detection model is detection model A “BACnet Anomaly Write Cmd”, and takes the first alert as the target for the cause identification rate update.

(S652) Cause identification rate calculator 250 identifies the detection model for alert 501 to be updated from detection model storage 320, and obtains the confirmation items included in the detection model. In addition, the alert No. of alert 501 to be updated, and the corresponding confirmed items, are obtained from confirmed item storage 310. Then, unconfirmed items on the site 110 side and SOC 140 side are extracted from the difference between the obtained confirmation items and confirmed items.

Here, the unconfirmed items are the confirmation items among the confirmation items included in the confirmation item list for alert 501 to be updated, excluding the confirmation items input to the confirmed item list. In the present embodiment, the confirmation item list for the first alert, which is to be updated, is as illustrated in FIG. 7, and the confirmed item list is as illustrated in FIG. 16. In other words, no confirmation items have yet been input to the SOC-side confirmed items, and thus the SOC-side unconfirmed items are No. 1, 2, 3, 4, and 5. The confirmation item No. 1 has been input to the site-side confirmed items, and thus the site-side unconfirmed items are No. 2, 3, 4, and 5.

(S653) Cause identification rate calculator 250 calculates and updates the site-side cause identification rate and SOC-side cause identification rate for alert No. 1, which is to be updated, using the site-side unconfirmed items and the SOC-side unconfirmed items. The site-side cause identification rate is calculated through Formula 5, and the SOC-side cause identification rate is calculated through Formula 6.

$$\begin{matrix}[ Math 5 ] & \\ Site ‐ side cause identification rate = \frac{( Sum of weights of site ‐ side unconfirmed items )}{\{ ( Sum of weights of SOC ‐ side unconfirmed items ) + ( Sum of weights of site ‐ side unconfirmed items ) \}} & ( Formula 5 )\end{matrix}$$

$$\begin{matrix}[ Math 6 ] & \\ SOC ‐ side cause identification rate = \frac{( Sum of weights of SOC ‐ side unconfirmed items )}{\{ ( Sum of weights of SOC ‐ side unconfirmed items ) + ( Sum of weights of site ‐ side unconfirmed items ) \}} & ( Formula 6 )\end{matrix}$$

The sum of the weights of the site-side unconfirmed items is obtained by totaling the weights of the confirmation items stored in the site-side confirmation item list. Similarly, the sum of the weights of the SOC-side confirmation items is obtained by totaling the weights of the confirmation items stored in the SOC-side confirmation item list.

The site-side unconfirmed items in the first alert, which is to be updated, are No. 2, 3, 4, and 5, and thus the total weight of the site-side unconfirmed items is 57. Furthermore, the SOC-side unconfirmed items are No. 1, 2, 3, 4, and 5, and thus the total weight of the SOC-side unconfirmed items is 48.

According to Formula 5, the site-side cause identification rate is 57/(48+57)=0.543 . . . , calculated as 54%, and according to Formula 6, the SOC-side cause identification rate is 48/(48+57)=0.447 . . . , calculated as 46%.

In other words, the site-side cause identification rate for the first alert is updated to 54%, and the SOC-side cause identification rate is updated to 46%.

The descriptions will return to the handling priority update processing illustrated in FIG. 17.

(S643) Handling priority calculator 260 obtains the alert score corresponding to the severity of alert No. 1, which is to be updated, from alert severity score storage 400. Handling priority calculator 260 then calculates the site-side handling priority and SOC-side handling priority using the site-side cause identification rate and SOC-side cause identification rate updated and the alert score obtained, and updates both priorities.

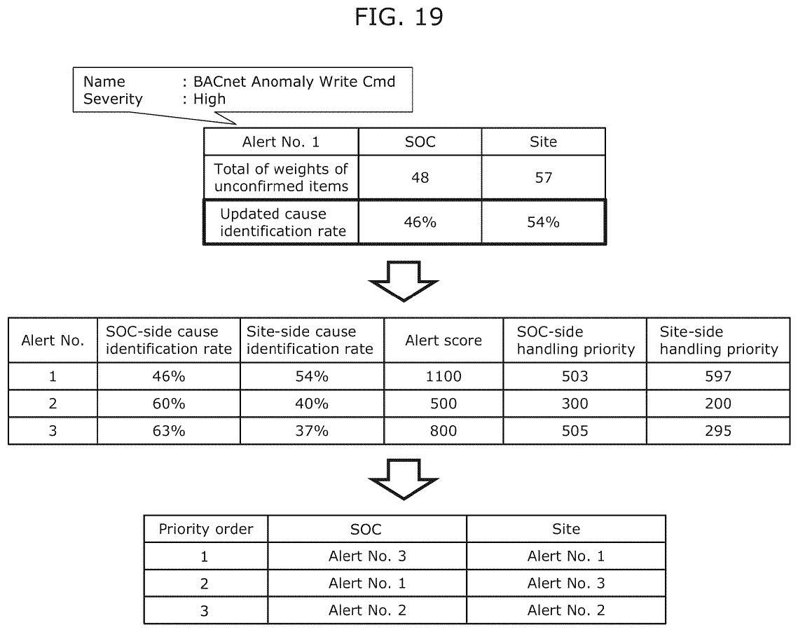

FIG. 19 is a diagram illustrating a calculation sequence and calculation results of the handling priority update processing for the first alert, which is to be updated, according to the present embodiment.

Similar to step S615 in FIG. 15, handling priority calculator 260 calculates the site-side handling priority through Formula 3, and calculates the SOC-side handling priority through Formula 4. In other words, the site-side handling priority is calculated as 0.543×1100=597 through Formula 3, and the SOC-side handling priority is calculated as 0.447×1100=503 through Formula 4.

When the site-side handling priority and SOC-side handling priority are updated, the priority orders for both administrator 130 and analyst 150 for each alert are also updated. If the priority orders are updated and a change occurs, the alerts which administrator 130 and analyst 150 handle next may also change. In the present embodiment, the priority order for the handling by administrator 130 of site 110 after the handling priority update is the first alert, the third alert, and the second alert, and the priority order for the handling by analyst 150 of SOC 140 is the third alert, the first alert, and the second alert, as illustrated in FIG. 19. In other words, this indicates that, because no changes due to the priority orders being updated have occurred, administrator 130 should continue to prioritize the handling of the first alert, and analyst 150 should prioritize the handling of the third alert.

Additionally, handling priority calculator 260 notifies outputter 270 of the site-side handling priority and SOC-side handling priority updated, and the priority orders of the handling by administrator 130 and analyst 150.

(S644) Outputter 270 outputs the handling priorities updated in step S643 and the priority order of the alert handling, and ends the handling priority update processing. Similar to step S616, the output result is displayed in a UI of at least one of anomaly detection device 500, the information terminal of analyst 150, and the information terminal of administrator 130, via communicator 280. At least one of administrator 130 and analyst 150 is then notified through the UI display.

In addition to the calculation sequence and the calculation result of the handling priority update processing illustrated in FIG. 19, the output result may include the alert information of alert 501 illustrated in FIG. 4, the content of the confirmation item list illustrated in FIG. 7 corresponding to the alert, and the confirmation result, and the details thereof, at the current point in time.

Note that if, as a result of the handling priority update processing, both the site-side handling priority and the SOC-side handling priority are 0, i.e., if all confirmation items included in the SOC-side confirmation item list are confirmed by analyst 150 and all confirmation items included in the site-side confirmation item list are confirmed by administrator 130, the result is output to analyst 150.

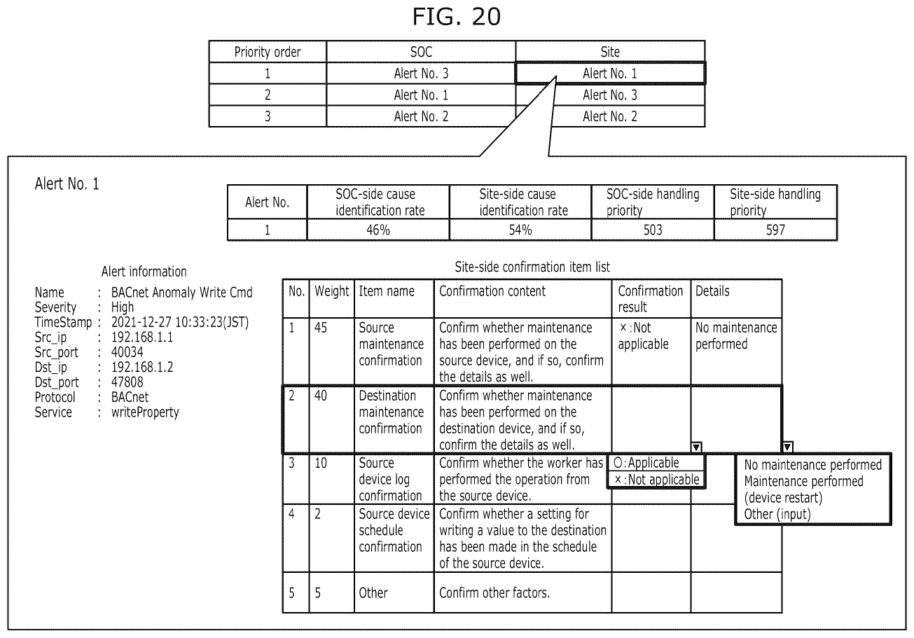

The handling priority update processing performed when the confirmation items are then confirmed by administrator 130, for the first alert for which the handling priority has been updated, will be described next. FIG. 20 illustrates the result of updating the handling priorities for the first alert, output to administrator 130 after the handling priorities are updated. In addition to the result of updating the handling priority for the first alert, FIG. 20 includes the priority order of the alert handling, the alert information for the alert illustrated in FIG. 4, the site-side confirmation item list, and the confirmation results, and the details thereof, up to the current point in time. FIG. 20 also serves as the UI for administrator 130 to input the confirmation results and the details thereof.

As illustrated in FIG. 20, administrator 130 should continue to handle the first alert, which is first in the priority order. Here, administrator 130 confirms the confirmation content for item No. 2, which is the confirmation item having the highest weight, excluding confirmation item No. 1 that has already been confirmed in the site-side confirmation item list for the first alert. Here, the item name is “destination maintenance confirmation”, and the confirmation content is “confirm whether maintenance has been performed on the destination device, and if so, confirm the details as well”.

It is assumed in the present embodiment that administrator 130 confirms the confirmation item, “a circle mark: applicable” is input to the confirmation result for the item No. 2, and “maintenance performed (device restart)” is input to the details. In this case, alert handling notification device 200 stores the item No. 2 in the site-side confirmation item list as a confirmed item through confirmation item input processing. Accordingly, alert handling notification device 200 performs the second instance of the handling priority update processing for the first alert.

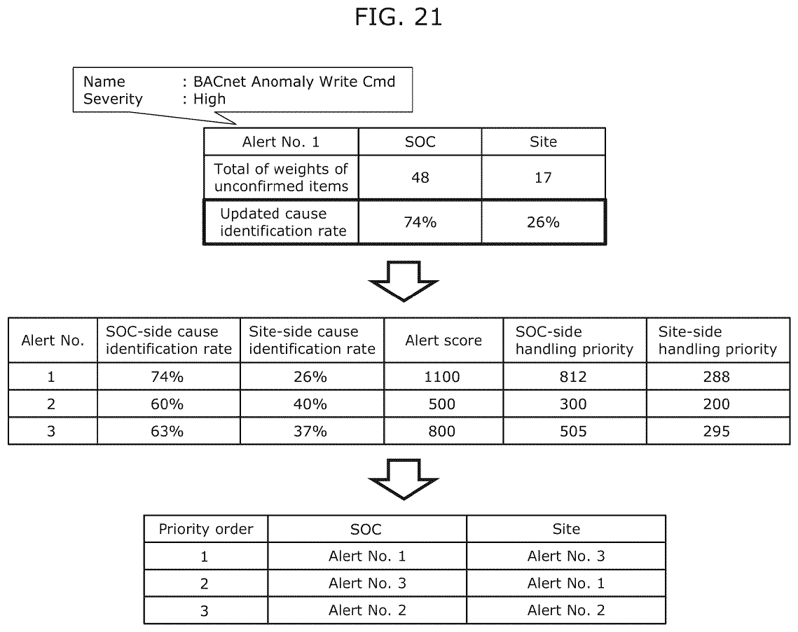

FIG. 21 is a diagram illustrating a calculation sequence and calculation results of the second instance of the handling priority update processing for the first alert, according to the present embodiment.

As a result of the confirmation item input processing, the SOC-side unconfirmed items do not change, and thus the total weight of the SOC-side unconfirmed items remains 48. In contrast, the site-side confirmed items include the items No. 1 and No. 2, and thus the site-side unconfirmed items are the items No. 3, 4, and 5, resulting in the total weight of the site-side unconfirmed items being 17. Accordingly, in the cause identification rate update processing of step S642, according to Formula 5, the site-side cause identification rate is 17/(48+17)=0.262, calculated as 26%, and according to Formula 6, the SOC-side cause identification rate is 48/(48+17)=0.738, calculated as 74%. In other words, the site-side cause identification rate for the first alert is updated to 52%, and the SOC-side cause identification rate is updated to 48%.

Next, in step S643 of the handling priority update processing, the site-side handling priority is calculated as 0.26×1100=288 through Formula 3, and the SOC-side handling priority is calculated as 0.74×1100=812 through Formula 4. In other words, the site-side handling priority for the first alert is updated to 288, and the SOC-side handling priority is updated to 812.

In addition, with the update of the handling priority, the priority orders for both administrator 130 and analyst 150 for each alert are further updated. In the present embodiment, the priority order for the handling by administrator 130 of site 110 after the second handling priority update is the third alert, the first alert, and the second alert, and the priority order for the handling by analyst 150 of SOC 140 is the first alert, the third alert, and the second alert, as illustrated in FIG. 21. Accordingly, because the priority orders have changed due to the second update, the alerts which administrator 130 and analyst 150 are to handle next also change. In other words, this indicates that administrator 130 should prioritize the handling of the third alert next, and analyst 150 should prioritize the handling of the first alert next. Accordingly, as a result of the priority order being updated, analyst 150 handles the alert in light of the result of the confirmation by administrator 130 of site 110 for the first alert.

The handling of the alert by analyst 150 will be described next. Like administrator 130, analyst 150 typically handles alerts in order from the alert highest in the priority order. Here, if the alert to be handled is a new alert, or if there is no event corresponding to the confirmation content that has already been confirmed by administrator 130 of site 110, and the confirmation result is “x: not applicable”, the SOC-side confirmation items are confirmed as the handling of the alert, in the same manner as with administrator 130. Then, if, while confirming the SOC-side confirmation item, an event corresponding to the confirmation content occurs and the confirmation result is “a circle mark: applicable”, analyst 150 specifies the true cause. Alternatively, if the confirmation has already been made by administrator 130, an event corresponding to the confirmation content has occurred, and an alert for which the confirmation result is “a circle mark: applicable” is to be handled by analyst 150, the true cause is specified immediately. In addition, if the confirmation of all confirmation items included in the SOC-side confirmation item list is complete and the confirmation of all confirmation items included in the site-side confirmation item list has been made by administrator 130, the true cause is specified immediately even if neither confirmation result is “a circle mark: applicable”.

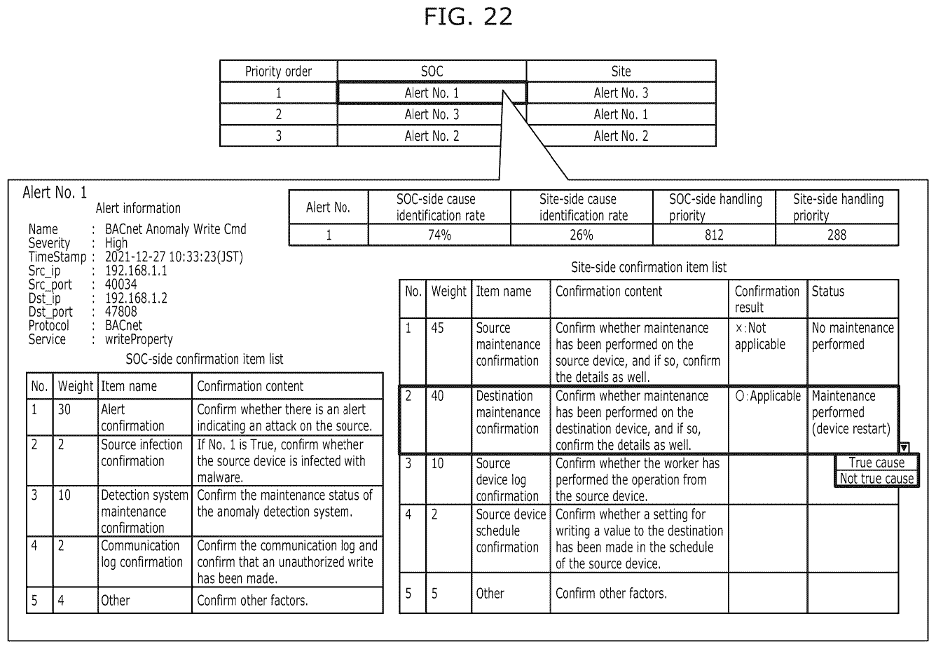

FIG. 22 illustrates an output result of which analyst 150 is notified after two instances of the handling priority update processing have been performed for the first alert, in the present embodiment. In addition to the result of the second update of the handling priority for the first alert, FIG. 22 includes the priority order of the alert handling, the alert information for the alert illustrated in FIG. 4, the SOC-side confirmation item list, the site-side confirmation item list, and the confirmation results, and the details thereof, up to the current point in time. FIG. 22 also serves as the UI for analyst 150 to input the item specified as the true cause. In FIG. 22, “a circle mark: applicable” is input for the confirmation result for item No. 2 in the site-side confirmed item list. In other words, because the first alert is an alert for which the confirmation has already been made by administrator 130 and for which there is an event corresponding to the confirmation content, analyst 150 immediately specifies the true cause.

The true cause is normally specified by analyst 150 confirming that the item for which the event corresponding to the confirmation content occurred is a factor for the occurrence of the alert, by analyzing logs such as the communication log and the control log. For example, in the present embodiment, for the first alert for which the confirmation has been made by administrator 130, and for which a notification indicating the event corresponding to item No. 2 in the site-side confirmation item list has been made, it is established whether the event “maintenance was performed on the destination device and the destination device was restarted”, indicated by that confirmation result, is a factor in the first alert having been issued. Then, if the confirmation through log analysis establishes that the first alert was issued due to the maintenance on the destination device, the item No. 2 in the site-side confirmation item list is specified as the true cause of the first alert. Conversely, if the confirmation result does not establish that the item is a factor in the first alert being issued, analyst 150 stops specifying the true cause and confirms the SOC-side confirmation item list.

If analyst 150 has specified the true cause, analyst 150 uses the UI for inputting the true cause, illustrated in FIG. 22, to input the item specified as the true cause as the true cause. The information input is input to true cause input acceptor 210 from the information terminal of analyst 150 displaying the UI, via anomaly detection device 500 and communicator 280.

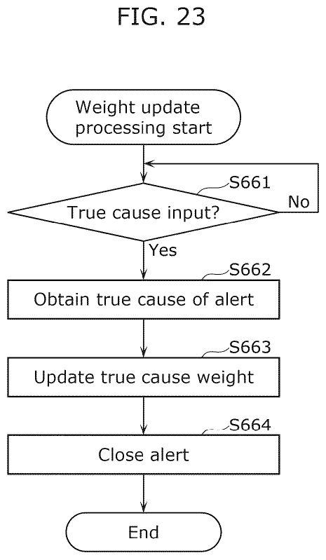

If the true cause of the alert being issued is input by analyst 150, alert handling notification device 200 performs the weight update processing on the confirmation item for the alert for which the true cause has been input. The weight update processing will be described in detail. FIG. 23 is a flowchart of the weight update processing according to the present embodiment.

(S661) Alert handling notification device 200 stands by until the true cause of the alert being issued is input to true cause input acceptor 210 by analyst 150, and when the true cause of the alert being issued is input, performs the processing of step S662. Here, the true cause is input by analyst 150, for example, through the input of the UI displayed in the information terminal of analyst 150, or the UI displayed in anomaly detection device 500. In the present embodiment, No. 2 in the site-side confirmation item illustrated in FIG. 22 has been specified as the true cause of the alert being issued, having been established through the log analysis by analyst 150 after the confirmation by administrator 130. As such, analyst 150 inputs that the true cause is No. 2 of the site-side confirmation items, and the input information is input to true cause input acceptor 210 via communicator 280.

(S662) Weight update processor 220 obtains the information on the true cause input from true cause input acceptor 210. The information on the true cause includes the alert information on the alert for which the true cause has been input, the confirmation item input as the true cause, and information about the detection model in which the confirmation item is included.

(S663) Weight update processor 220 updates the weight in the confirmation item list included in the detection model corresponding to the alert, stored in detection model storage 320, based on the information obtained in step S662. The item for which the weight has been updated is applied when an alert in the same detection model occurs the next and subsequent times. The updating of the weight is performed for the weight of the confirmation item input as the true cause, by adding 1 to the current weight, for example. The value to be added may be a value such as 2 or 3 instead of 1, and the value may be set in accordance with the operation policy of the organization. Note that updating the weight is not limited to addition, and may be performed by multiplication. In other words, when updating the weight, if the weight corresponding to the item specified as the true cause is updated so as to be increased, the update may be performed by adding a specific value, or by multiplying by a value greater than 1.

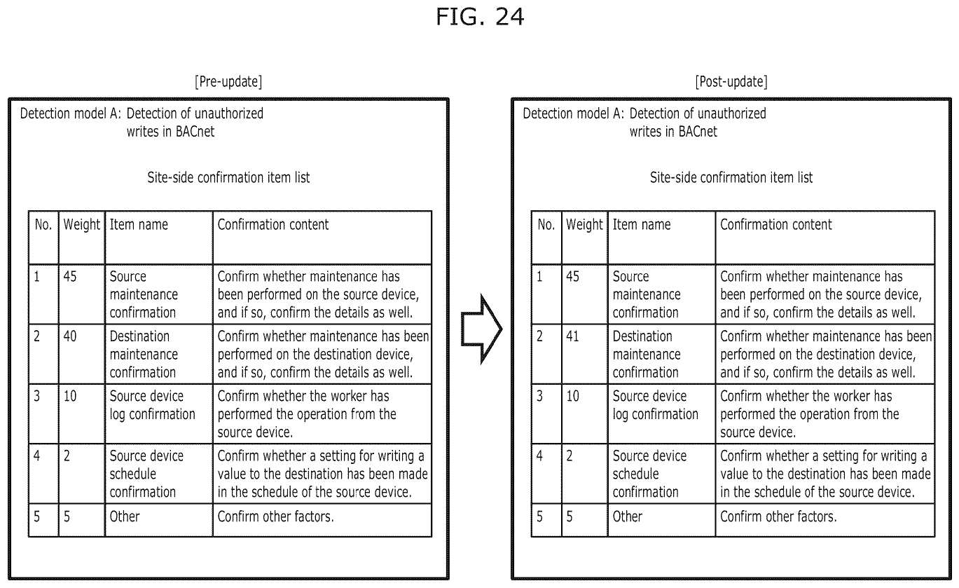

FIG. 24 is a diagram illustrating an example of the updating of weights in the confirmation item list of detection model A according to the present embodiment. FIG. 24 illustrates a case where the item name “destination maintenance confirmation” for the confirmation item of No. 2 in the site-side confirmation item list of detection model A is the true cause. Before the update, the weight of the item name “destination maintenance confirmation” is 40, and becomes 41 after the update. Normally, only the item for which the weight is updated through the updating is the item for which the true cause is input, but if there are a plurality of true causes, a plurality of items may be updated.

(S664) Alert handling notification device 200 closes the alert for which the true cause has been input, and ends the handling of the alert. In addition, the cause identification rate, handling priority, priority order, and the like for the closed alert are deleted from the output result of which administrator 130 and analyst 150 are notified.

The confirmation items are not confirmed by administrator 130 and analyst 150 after the alert is closed. In the present embodiment, No. 2 in the site-side confirmation item list has been input as the true cause, and the first alert has been closed. Accordingly, administrator 130 need not confirm items No. 3, 4, and 5 in the site-side confirmation item list for the first alert, and analyst 150 need not confirm items No. 1 to 5 in the SOC-side confirmation item list.

### Effects of Embodiment

According to alert handling notification device 200 according to the present embodiment, when alert 501 is issued, calculating the cause identification rate based on a weight of the confirmation item that reflects analysis results for previous alerts makes it possible to determine whether administrator 130 on the site 110 side or analyst 150 on the SOC 140 side should perform the status confirmation for alert 501 first, and notify that party along with information for the status confirmation.

The notification from alert handling notification device 200 enables analyst 150 to recognize whether they should immediately start the confirmation for the confirmation item as the status confirmation for the alert for which the notification was made, or, conversely, whether they should wait for the confirmation item to be confirmed by administrator 130 and a notification to be made for the information from site 110. In addition, administrator 130 can recognize whether it is necessary to confirm the confirmation items for the alert for which the notification was made, and input the confirmation results.

In this manner, analyst 150 and administrator 130 can each recognize whether the other party should perform a status confirmation for the alert for which the notification was made, which makes it possible to streamline the handling of alerts.

In addition, according to alert handling notification device 200 according to the present embodiment, administrator 130 and analyst 150 can be notified of the handling priorities calculated based on the cause identification rate and the degree expressing the magnitude of the impact of alert 501. The handling priority is a degree indicating a priority order for the alerts to be handled, among at least one alert 501 for which the cause is to be analyzed.

As such, administrator 130 and analyst 150 can recognize which alert to proceed with the handling, to when notifications for a plurality of alerts are made. For example, analyst 150 can recognize that the handling should proceed from an alert having a high SOC-side cause identification rate and a correspondingly high SOC-side handling priority, for which the analysis can be started immediately, rather than from an alert that, because information from site 110 is necessary, has a low SOC-side cause identification rate and therefore has a low SOC-side handling priority. Additionally, for example, even if the cause identification rates are the same for a plurality of alerts, the handling priority changes when the magnitude of the impact of each alert is different. It is therefore possible to recognize which alert is the alert having the largest impact, and proceed with the handling in order.

As a result, having administrator 130 and analyst 150 proceed with the handling of the alerts according to the priority order indicated by the handling priorities makes it possible to streamline the handling of the alerts and suppress the influence on control system 120 and the like.

In addition, according to alert handling notification device 200 according to the present embodiment, the cause identification rate and handling priorities can be updated dynamically according to the progress of the handling of the alerts, and administrator 130 and analyst 150 can be notified thereof. As such, for example, analyst 150 can recognize whether to continue the analysis or obtain information about site 110 for the alert being analyzed, and administrator 130 can recognize whether to continue the confirmation work for site 110 and providing information to analyst 150, or to return to normal operations.

As a result, administrator 130 and analyst 150 can select the optimal handling at that point in time for the alert being handled, i.e., whether to continue the handling, suspend the handling and switch to handling another alert, or terminate the handling entirely.

In addition, according to alert handling notification device 200 according to the present embodiment, each time analysis of an alert is completed, the weight, which is a degree indicating the likelihood of being a factor in the alert having been issued, can be updated. The weight indicates the priority order for the confirmation of each confirmation item in the confirmation item list for a given alert 501, and is used to calculate the cause identification rate.

This makes it possible to reflect past trends, results of analyzing factors, and the like for the same types of alerts in the priority order of confirmations for confirmation items, cause identification rates, and the like, which in turn makes it possible to further streamline the handling of the alerts.

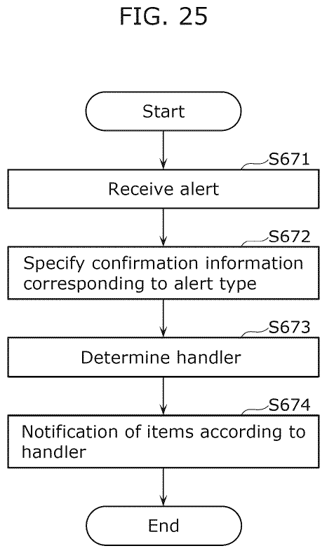

The alert handling notification method according to the present embodiment may be executed as illustrated in FIG. 25. The alert handling notification method is an alert handling notification method executed by alert handling notification device 200. In the alert handling notification method, alert handling notification device 200 receives an alert indicating an anomaly that has occurred in an OT environment (S671). Next, alert handling notification device 200 identifies a confirmation information item corresponding to a type of the alert received, based on the alert and a plurality of confirmation information items stored in storage 300 included in alert handling notification device 200, the plurality of confirmation information items each indicating content of a status confirmation for an alert of a type corresponding to the confirmation information item (S672). Here, each of the plurality of confirmation information items includes a first item associated with a first weight and indicating content of a first status confirmation made by a first handler (one item included in the SOC-side confirmation item list), and a second item associated with a second weight and indicating content of a second status confirmation made by a second handler (one item included in the site-side confirmation item list). Next, alert handling notification device 200 determines a handler, among the first handler (analyst 150) and the second handler (administrator 130), to be preferentially caused to make a status confirmation for the alert received, using the first weight and the second weight specified based on the confirmation information item identified (S673). Alert handling notification device 200 makes a notification of the item according to the handler determined (S674). Specifically, alert handling notification device 200 notifies the first handler of the first item when the first handler is determined to be the handler, and notifies the second handler of the second item when the second handler is determined to be the handler.

Through this, an appropriate handler can be determined for each alert, and the handler can be notified along with information for the status confirmation, making it possible to streamline the handling of the alerts.

The alert handling notification method according to the present embodiment further includes notifying the second handler of the second item when first completion information indicating that the first handler has completed the first status confirmation is received, and notifying the first handler of the first item when second completion information indicating that the second handler has completed the second status confirmation is received.

Through this, when the status confirmation by one handler is completed for an alert, the other handler can immediately be notified of the content of the status confirmation the next time.

In the alert handling notification method according to the present embodiment, each of the plurality of confirmation information items further includes a third item associated with a third weight and indicating content of a third status confirmation made by the first handler (another item included in the SOC-side confirmation item list), and a fourth item associated with a fourth weight and indicating content of a fourth status confirmation made by the second handler (another item included in the site-side confirmation item list). The determining includes determining the handler using the first weight, the second weight, the third weight, and the fourth weight specified based on the confirmation information item corresponding to the type of the alert received. The notifying of the first item includes notifying the first handler of the first item and the third item in order from the item having a greater weight. The notifying of the second item includes notifying the second handler of the second item and the fourth item in order from the item having a greater weight.

Through this, even if the content of the status confirmation performed by each handler for the alert includes a plurality of items, which of the first handler and the second handler is to perform the status confirmation for the alert first can be determined. In addition, the handler can be notified of the items for the status confirmation in order from the largest weight associated with each item, and the handler can proceed with the status confirmation efficiently.

The alert handling notification method according to the present embodiment further includes, when completion information indicating that one of the first status confirmation, the second status confirmation, the third status confirmation, or the fourth status confirmation is complete is received: redetermining the handler using one or more weights resulting from excluding, from the first weight, the second weight, the third weight, and the fourth weight, a weight associated with an item indicating content of a status confirmation indicated by the completion information as being complete; and notifying the handler of one or more items resulting from excluding, from the first item, the second item, the third item, and the fourth item, the item indicating the content of the status confirmation indicated by the completion information as being complete.

Through this, the determination for the handlers can be made dynamically according to the progress of the status confirmation for the alert, and the handlers can be notified in sequence.

In the alert handling notification method according to the present embodiment, the first handler is an analyst who analyzes a cause of the alert. The second handler is an administrator who manages the Operational Technology (OT) environment. The notifying of the second item further includes notifying the first handler that the second handler will make the status confirmation for the alert first.

Through this, the analyst can recognize when the administrator will perform the status confirmation for the issued alert first. In other words, the analyst can recognize the current situation even for an alert for which the analyst him/herself is not to perform the status confirmation first.

In the alert handling notification method according to the present embodiment, each of the plurality of confirmation information items further includes a third item associated with a third weight and indicating content of a third status confirmation made by the first handler, and a fourth item associated with a fourth weight and indicating content of a fourth status confirmation made by the second handler. The alert handling notification method further includes, when completion information indicating that the second status confirmation or the fourth status confirmation is complete is received: redetermining the handler using one weight resulting from excluding, from the second weight and the fourth weight, a weight associated with an item indicating content of a status confirmation indicated by the completion information as being complete; notifying the first handler of (i) the item indicating the content of the status confirmation indicated by the completion information as being complete and (ii) a confirmation result of the status confirmation; notifying the first handler of the first item when the first handler is determined to be the handler in the redetermining; and notifying the second handler of an item excluding the item indicating the content of the status confirmation indicated by the completion information as being complete, when the second handler is determined to be the handler in the redetermining.

Through this, the analyst can be notified of the item for which the status confirmation has been performed by the administrator, and the information on the site obtained as a result of the status confirmation for the item. Accordingly, the analyst can handle the alert by performing the status confirmation, analyzing the cause, and the like after obtaining the information on the site.

The alert handling notification method according to the present embodiment further includes: receiving, from the first handler, a true cause item indicating an item related to a cause of the alert; specifying an item indicated by the true cause item, among the first item, the second item, the third item, and the fourth item; and updating a weight associated with the item specified, to increase the weight.

Through this, when the same type of alert is issued and a notification is made the next or subsequent time, which of the first handler and the second handler should perform the status confirmation first can be determined using the updated weight. In other words, the determination can be made taking into account a history of handling of alerts that have occurred in the past, which makes it possible to handle the alert efficiently.

In the alert handling notification method according to the present embodiment, the determining includes: calculating a first priority indicating a degree of priority with which the first handler is to make the status confirmation for the alert (the SOC-side cause identification rate), and a second priority indicating a degree of priority with which the second handler is to make the status confirmation for the alert (the site-side cause identification rate), using the first weight and the second weight; determining the first handler to be the handler when the first priority is higher than the second priority; and determining the second handler to be the handler when the second priority is higher than the first priority.

The alert handling notification method according to the present embodiment further includes, when a plurality of alerts are received in the receiving: calculating the first priority for each of the plurality of alerts received, and determining a first priority order for making the status confirmation for each of the plurality of alerts in order from the alert for which the first priority is highest; calculating the second priority for each of the plurality of alerts received, and determining a second priority order for making the status confirmation for each of the plurality of alerts in order from the alert for which the second priority is highest; notifying the first handler of (i) the first priority order and (ii) the first item corresponding to an alert, among the plurality of alerts, that is highest in the first priority order; and notifying the second handler of (i) the second priority order and (ii) the second item corresponding to an alert, among the plurality of alerts, that is highest in the second priority order.

Through this, when a plurality of alerts are received, the priority order of the status confirmation for the first handler can be determined, and a notification can be made, by comparing the calculated plurality of first priorities. Likewise, the priority order of the status confirmation for the second handler can be determined, and a notification can be made, by comparing the calculated plurality of second priorities. Accordingly, each handler can understand the priority order of the status confirmation even when a plurality of alerts have been issued, and can efficiently proceed with the handling of the alerts.

In the alert handling notification method according to the present embodiment, wherein when a plurality of alerts are received in the receiving, each of the plurality of alerts includes a severity indicating a magnitude of an impact of the alert. The alert handling notification method further includes: calculating a third priority for each of the plurality of alerts received by multiplying the first priority by the severity of the alert, and determining a first priority order for making the status confirmation for each of the plurality of alerts in order from the alert for which the third priority is highest; calculating a fourth priority for each of the plurality of alerts received by multiplying the second priority by the severity of the alert, and determining a second priority order for making the status confirmation for each of the plurality of alerts in order from the alert for which the fourth priority is highest; notifying the first handler of (i) the first priority order and (ii) the first item corresponding to an alert, among the plurality of alerts, that is highest in the first priority order; and notifying the second handler of (i) the second priority order and (ii) the second item corresponding to an alert, among the plurality of alerts, that is highest in the second priority order.

Through this, the priority order of the status confirmation can be determined taking into account the severity of the alert. Accordingly, the priority order of a status confirmation for an alert having a high severity can be determined to be higher compared to an alert having a low severity, and because the status confirmation is prioritized by the handler, the impact of the alert can be suppressed as a result.

In the alert handling notification method according to the present embodiment, each of the plurality of confirmation information items further includes a third item associated with a third weight and indicating content of a third status confirmation made by the first handler, and a fourth item associated with a fourth weight and indicating content of a fourth status confirmation made by the second handler. The alert handling notification method further includes, when completion information indicating that one of the first status confirmation, the second status confirmation, the third status confirmation, or the fourth status confirmation is complete is received: recalculating the first priority and the second priority using one or more weights among the first weight, the second weight, the third weight, and the fourth weight, excluding a weight associated with an item indicating content of a status confirmation indicated by the completion information as being complete.

In the alert handling notification method according to the present embodiment, each of the plurality of confirmation information items further includes a third item associated with a third weight and indicating content of a third status confirmation made by the first handler, and a fourth item associated with a fourth weight and indicating content of a fourth status confirmation made by the second handler. The alert handling notification method further includes, when completion information indicating that one of the first status confirmation, the second status confirmation, the third status confirmation, or the fourth status confirmation is complete is received: recalculating the first priority and the second priority using one or more weights resulting from excluding, from the first weight, the second weight, the third weight, and the fourth weight, a weight associated with an item indicating content of a status confirmation indicated by the completion information as being complete; and recalculating the third priority and the fourth priority using the first priority and the second priority for the alert that have been recalculated.

Through this, the priority order of the status confirmation for the alert can be updated dynamically according to the progress of the status confirmation by the handler, which makes it possible to streamline the handling of the alerts as a whole.

### Variations

In the foregoing, an embodiment has been given as an example of the technique according to the present disclosure. However, the technique in the present disclosure is not limited thereto, and can also be applied in embodiments in which modifications, replacements, additions, or omissions have been made as appropriate. For example, variations such as those described below are also included in the embodiments of the present disclosure.

(1) The foregoing embodiment assumed that the output result from alert handling notification device 200 is displayed in a UI of at least one of the information terminal of analyst 150 or the information terminal of administrator 130 via anomaly detection device 500. However, alert handling notification device 200 may output the result to an external server, the cloud, or the like over the information communication network. In addition, administrator 130 and analyst 150 may request administrator 130 and analyst 150 to perform user authentication when obtaining an output result output to anomaly detection device 500, an external server, the cloud, or the like through communication using the information terminals. Alternatively, an output specific to a user identified through user authentication may be made. For example, the content of the output may be changed, such as making an output to administrator 130 by, for example, displaying the site-side confirmation item list when a request is authenticated as a request for the output result from administrator 130, or making an output to analyst 150 by, for example, displaying both the site-side confirmation item list and the SOC-side confirmation item list when a request is authenticated as a request for the output result from analyst 150.

(2) The foregoing embodiment described the handling priority update processing as being performed each time the confirmation item input processing is performed and the confirmed item is updated. However, the handling priority update processing may be performed every set period of time, regardless of updates to the confirmed items. The set period of time may be tens of minutes or hours, or may be every day. Additionally, for example, the handling priority update processing may be performed in sequence for all alerts having notifications, every set period of time; or the handling priority update processing may be performed sequentially, starting with an alert for which a set period of time has passed following the notification or the previous update to the handling priority.

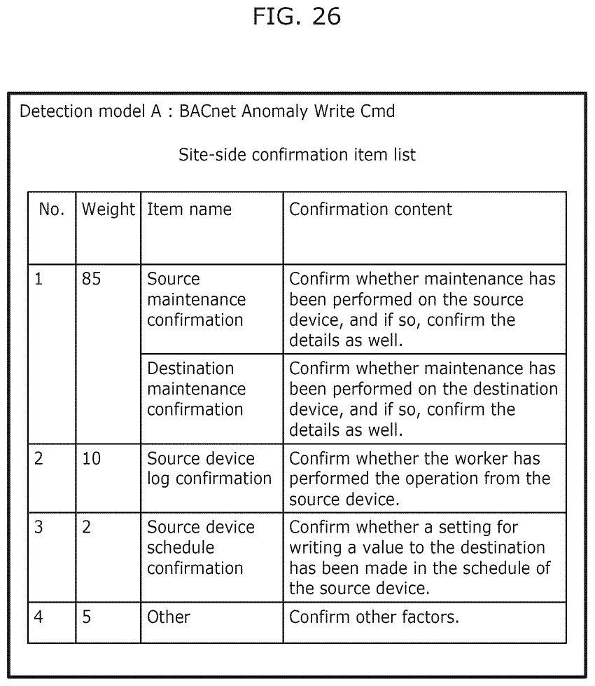

(3) The foregoing embodiment described one matter for confirmation as being included in one confirmation item in each confirmation item list included in the detection model. However, the configuration of the confirmation item list is not limited thereto. For example, a plurality of matters for confirmation may be included in a single confirmation item. The site-side confirmation item list illustrated in FIG. 26 is one example. The site-side confirmation item list in FIG. 26 is a variation on the site-side confirmation item list illustrated in FIG. 7. The two confirmation items No. 1 and 2 in the site-side confirmation item list in FIG. 7, namely the item names “source maintenance confirmation” and “destination maintenance confirmation”, have been combined into a single confirmation item. In FIG. 26, the two items are combined, and the weights associated with the confirmation items are also integrated, such that the weights that were “45” and “40” are now “85”. By configuring the confirmation item list in this manner, for example, administrator 130 or analyst 150 can recognize that a plurality of confirmation items having similar confirmation content, a plurality of confirmation items that can be confirmed more efficiently together than individually, or the like should be confirmed together, which makes it possible to further streamline the handling of the alerts.

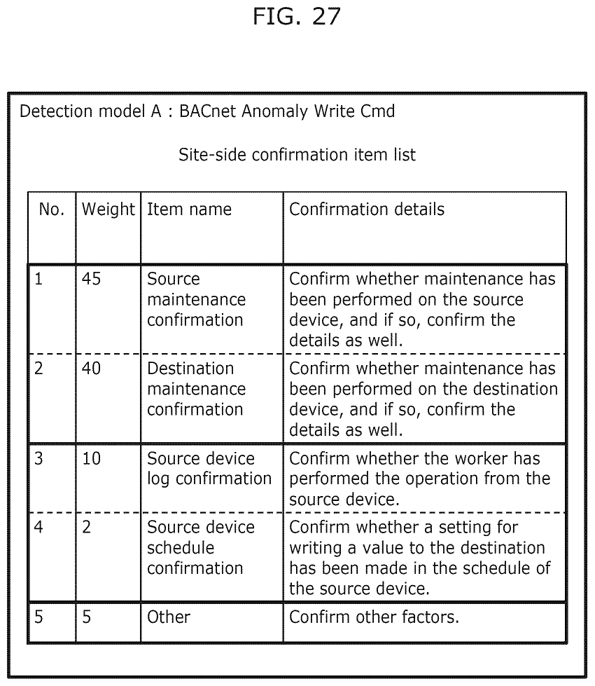

(4) In the foregoing embodiment, in the confirmation of the confirmation items by administrator 130 and analyst 150, the confirmation result is input each time a single confirmation item is confirmed, and the handling priority updated in response thereto is referred to to determine whether to confirm the next confirmation item or suspend the confirmation. However, the confirmation result may be input after confirming a plurality of confirmation items together, rather than a single confirmation item. For example, in addition to a plurality of confirmation items having similar confirmation content, a plurality of confirmation items that can be confirmed more efficiently together than individually, or the like, a plurality of confirmation items having weights that are at least a set magnitude or the like may be confirmed together, and the confirmation result may then be input. Additionally, a plurality of confirmation items that are more efficiently confirmed together as described above may be grouped together and displayed in a confirmation item list or the like. The site-side confirmation item list illustrated in FIG. 27 is one example. The site-side confirmation item list in FIG. 27 is a variation on the site-side confirmation item list illustrated in FIG. 7. Here, there are three groups, namely confirmation items having a weight of at least 15, confirmation items having a weight of less than 15, and others. In other words, the confirmation items No. 1 and No. 2 are in one group; No. 3 and No. 4, in another group; and No. 5 (others) in yet another group. Accordingly, administrator 130 can recognize that confirmation items No. 1 and No. 2 are to be confirmed together first. Configuring the confirmation item list in this manner enables administrator 130 and analyst 150 to recognize confirmation items that should be confirmed together at one time, which makes it possible to further streamline the handling of the alerts.

(5) When a notification is made for one alert, alert handling notification device 200 may immediately notify the second handler of the second item when the first handler has already performed the status confirmation for the first item, and may immediately notify the first handler of the first item when the second handler has already performed the status confirmation for the second item. In the foregoing embodiment, when, for example, analyst 150 performs the status confirmation first, if analyst 150 has confirmed all the confirmation items in the SOC-side confirmation item list, alert handling notification device 200 may immediately notify administrator 130 that the next confirmation should be performed, along with the confirmation item. When administrator 130 performs the status confirmation first, if administrator 130 has confirmed all the confirmation items included in the site-side confirmation item list, alert handling notification device 200 may immediately notify analyst 150 that the next confirmation should be performed, along with the confirmation item and the confirmation result from administrator 130. Through this, when there are no more items to be confirmed by one handler, the other handler can quickly start the confirmation.

(6) In the foregoing embodiment, the output results such as the cause identification rate, handling priority, priority order, and the like, of which administrator 130 and analyst 150 are notified, are displayed in the UI in list format as indicated in FIGS. 10, 13, and 20, and the alert information, confirmation item lists, and the like for a predetermined alert are furthermore displayed as well. However, the display of the output result is not limited thereto, and matters may be replaced or omitted as appropriate. For example, as long as the priority order for handling of the alerts can be recognized, the display of the cause identification rate, the handling priority, and the like for the predetermined alert may be omitted from the output to administrator 130. Additionally, alert information such as the name, severity, or the like may be omitted from the display, as matters not directly related to the confirmation content of the site-side confirmation item list.

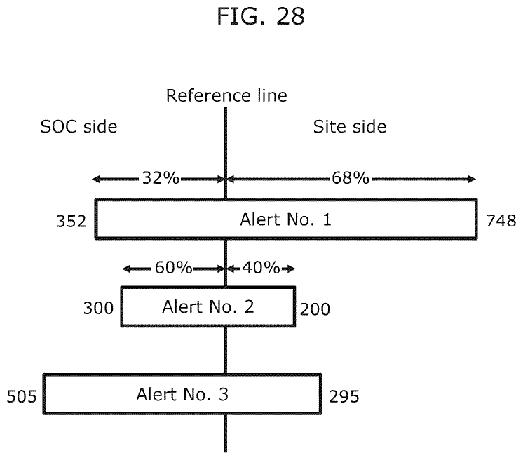

(7) In addition to a list format, the output results such as the cause identification rate, handling priority, priority order, and the like may be displayed in the UI in bar format, for example. FIG. 28 illustrates an example of a UI display in bar format. FIG. 28 indicates each cause identification rate, alert score, and handling priority, from the first to third alerts illustrated in FIG. 12 of the present embodiment, in bar format.

In FIG. 28, each alert is indicated by a single bar, and the format includes three bars representing the first, second, and third alerts, as well as a reference line. Here, the length of each bar corresponds to the magnitude of the alert score associated with each alert, with the length of the bar for the first alert being 1100, the length of the bar for the second alert being 500, and the length of the bar for the third alert being 800.

In addition, the bars are arranged at equal intervals in the vertical direction of the drawing in, for example, order of the alert number, and are arranged in the horizontal direction such that the percentages indicated by the SOC-side cause identification rate and the site-side cause identification rate correspond with respect to the reference line. For example, when the area on the SOC 140 side is on the left side of the reference line and the area on the site 110 side is on the right side of the reference line, as in FIG. 28, because the SOC-side cause identification rate for the first alert is 32% and the site-side cause identification rate is 68%, 32% of the first alert bar from the left end is within the area on the SOC 140 side, and 68% from the right end is within the area on the site 110 side. In other words, the SOC-side cause identification rate and site-side cause identification rate of the alert indicated by the bar are represented by the positioning of the bar in the horizontal direction.

The length from the reference line to the left end of each bar and the length to the right end of each bar are indicated on the right and left sides of each bar, respectively. The length from the reference line to the left end of the bar for the bar of the first alert is 0.32×1100=352, and the length from the reference line to the right end of the bar is 0.68×1100=748. These formulas and values match the formula for calculating the SOC-side handling priority indicated by Formula 3, the formula for calculating the site-side handling priority indicated by Formula 4, and each handling priority for the first alert, respectively. In other words, the lengths from the reference line to the left and right ends of each bar represent the SOC-side handling priority and site-side handling priority for the alert indicated by that bar. Accordingly, when the bar of at least one alert is displayed as illustrated in FIG. 28, the bar having the greatest length from the reference line to the left end of the bar indicates the alert first in the priority order for the handling on the SOC 140 side, and the bar having the greatest length from the reference line to the right end of the bar indicates the alert first in the priority order for the handling on the site 110 side.

Indicating the cause identification rate, handling priority, and priority order in bar format in this manner enables administrator 130 and analyst 150 to visually recognize the priority order of the alerts, the handling statuses for a plurality of alerts, and the like without looking at specific values. Additionally, the arrangement of the bars for the alerts can be updated when various types of values are updated in the handling priority update processing, or at any other desired timing. In FIG. 28, the area on the right side may be set to be the area on the SOC 140 side, and the area on the left side may be set to be the area on the site 110 side; and the display of the percentage representing the cause identification rate, the value indicating the handling priority, or the like may be omitted.

In addition, the alert information for the alert, the confirmation item list, the confirmation result and the details thereof for each item in the confirmation item list, and the like may be displayed when the bar of a given alert is selected. Furthermore, these displays may be combined with the UI for inputting the confirmation result and the details thereof, the UI for inputting the true cause, and the like. In addition, the stated display may always be provided for the alert highest in the priority order for the site 110 side and the SOC 140 side, even if the bar for a given alert is not selected. Note that the stated display may be set to any position in the UI that is the same as in the bar format output of FIG. 28, or may be displayed separately in a UI that is different from the bar format output.

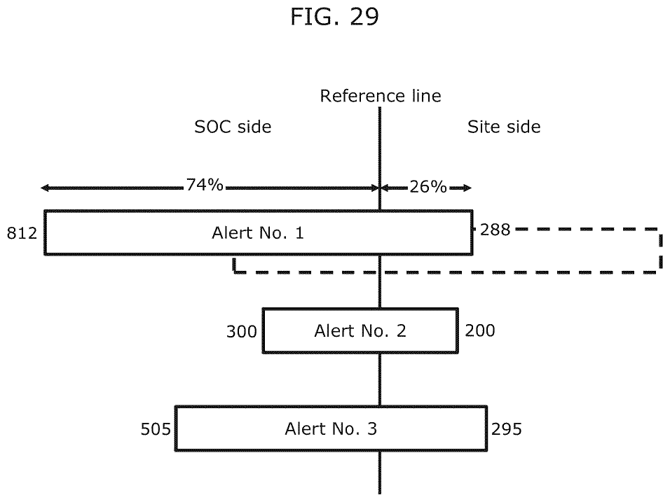

(8) Furthermore, in the foregoing variation (7), information such as an update history, transitions, and the like of the handling priority for each alert may be displayed in conjunction with the corresponding bar as a trajectory. FIG. 29 illustrates an example of the display of a trajectory. FIG. 29 illustrates a bar format output indicating the handling priority and the like for the first, second, and third alerts, after the second instance of the handling priority update processing has been performed for the first alert in the foregoing embodiment, and corresponds to the state illustrated in FIG. 21. In FIG. 29, the bar for the first alert changes from the location of the first alert illustrated in FIG. 28 as a result of the second instance of the handling priority update processing. Here, the position of the first alert illustrated in FIG. 28, i.e., the history information indicating the initial state at the time when the notification for the alert was made, is indicated by a dotted line as a trajectory. Displaying the trajectory in a bar format output in this manner enables, for example, administrator 130 to recognize that the priority order on the site 110 side has fallen as a result of the confirmation made for the first alert, and enables analyst 150 to recognize that the situation has changed to one in which the first alert should be handled preferentially. In other words, changes in the handling history and handling status for the alert can be recognized visually. Note that the trajectory to be displayed may, in addition to the initial handling priority or the like from when the notification of the alert was made, indicate the handling priority or the like up until the most recent handling priority update processing was performed, or the handling priority or the like a set period of time earlier. Additionally, the display is not limited to a single trajectory, and a plurality of trajectories may be displayed, such as displaying a trajectory each time an update is made.

### INDUSTRIAL APPLICABILITY

The present disclosure is useful in selecting a handler to prioritize, for the purpose of streamlining the analysis of alerts generated by a control system.

1. An alert handling notification method executed by an alert handling notification device, the alert handling notification method comprising:
receiving an alert indicating an anomaly that has occurred in an Operational Technology (OT) environment;
identifying a confirmation information item corresponding to a type of the alert received, based on the alert and a plurality of confirmation information items stored in storage, the storage being included in the alert handling notification device, the plurality of confirmation information items each indicating content of a status confirmation for an alert of a type corresponding to the confirmation information item, and each including a first item associated with a first weight and indicating content of a first status confirmation made by a first handler, and a second item associated with a second weight and indicating content of a second status confirmation made by a second handler;
determining a handler, among the first handler and the second handler, to be preferentially caused to make a status confirmation for the alert received, using the first weight and the second weight specified based on the confirmation information item identified;
notifying the first handler of the first item when the first handler is determined to be the handler; and
notifying the second handler of the second item when the second handler is determined to be the handler.

2. The alert handling notification method according to claim 1, further comprising:
notifying the second handler of the second item when first completion information indicating that the first handler has completed the first status confirmation is received; and
notifying the first handler of the first item when second completion information indicating that the second handler has completed the second status confirmation is received.

3. The alert handling notification method according to claim 1,
wherein each of the plurality of confirmation information items further includes a third item associated with a third weight and indicating content of a third status confirmation made by the first handler, and a fourth item associated with a fourth weight and indicating content of a fourth status confirmation made by the second handler,
the determining includes determining the handler using the first weight, the second weight, the third weight, and the fourth weight specified based on the confirmation information item corresponding to the type of the alert received,
the notifying of the first item includes notifying the first handler of the first item and the third item in order from the item having a greater weight, and
the notifying of the second item includes notifying the second handler of the second item and the fourth item in order from the item having a greater weight.

4. The alert handling notification method according to claim 3, further comprising,
when completion information indicating that one of the first status confirmation, the second status confirmation, the third status confirmation, or the fourth status confirmation is complete is received:
redetermining the handler using one or more weights resulting from excluding, from the first weight, the second weight, the third weight, and the fourth weight, a weight associated with an item indicating content of a status confirmation indicated by the completion information as being complete; and
notifying the handler of one or more items resulting from excluding, from the first item, the second item, the third item, and the fourth item, the item indicating the content of the status confirmation indicated by the completion information as being complete.

5. The alert handling notification method according to claim 1,
wherein the first handler is an analyst who analyzes a cause of the alert,
the second handler is an administrator who manages the Operational Technology (OT) environment, and
the notifying of the second item further includes notifying the first handler that the second handler will make the status confirmation for the alert first.

6. The alert handling notification method according to claim 5,
wherein each of the plurality of confirmation information items further includes a third item associated with a third weight and indicating content of a third status confirmation made by the first handler, and a fourth item associated with a fourth weight and indicating content of a fourth status confirmation made by the second handler, and
the alert handling notification method further comprises,
when completion information indicating that the second status confirmation or the fourth status confirmation is complete is received:
redetermining the handler using one weight resulting from excluding, from the second weight and the fourth weight, a weight associated with an item indicating content of a status confirmation indicated by the completion information as being complete;
notifying the first handler of (i) the item indicating the content of the status confirmation indicated by the completion information as being complete and (ii) a confirmation result of the status confirmation;
notifying the first handler of the first item when the first handler is determined to be the handler in the redetermining; and
notifying the second handler of an item excluding the item indicating the content of the status confirmation indicated by the completion information as being complete, when the second handler is determined to be the handler in the redetermining.

7. The alert handling notification method according to claim 6, further comprising:
receiving, from the first handler, a true cause item indicating an item related to a cause of the alert;
specifying an item indicated by the true cause item, among the first item, the second item, the third item, and the fourth item; and
updating a weight associated with the item specified, to increase the weight.

8. The alert handling notification method according to claim 1,
wherein the determining includes:
calculating a first priority indicating a degree of priority with which the first handler is to make the status confirmation for the alert, and a second priority indicating a degree of priority with which the second handler is to make the status confirmation for the alert, using the first weight and the second weight;
determining the first handler to be the handler when the first priority is higher than the second priority; and
determining the second handler to be the handler when the second priority is higher than the first priority.

9. The alert handling notification method according to claim 8, further comprising,
when a plurality of alerts are received in the receiving:
calculating the first priority for each of the plurality of alerts received, and determining a first priority order for making the status confirmation for each of the plurality of alerts in order from the alert for which the first priority is highest;
calculating the second priority for each of the plurality of alerts received, and determining a second priority order for making the status confirmation for each of the plurality of alerts in order from the alert for which the second priority is highest;
notifying the first handler of (i) the first priority order and (ii) the first item corresponding to an alert, among the plurality of alerts, that is highest in the first priority order; and
notifying the second handler of (i) the second priority order and (ii) the second item corresponding to an alert, among the plurality of alerts, that is highest in the second priority order.

10. The alert handling notification method according to claim 8,
wherein when a plurality of alerts are received in the receiving, each of the plurality of alerts includes a severity indicating a magnitude of an impact of the alert, and
the alert handling notification method further comprises:
calculating a third priority for each of the plurality of alerts received by multiplying the first priority by the severity of the alert, and determining a first priority order for making the status confirmation for each of the plurality of alerts in order from the alert for which the third priority is highest;
calculating a fourth priority for each of the plurality of alerts received by multiplying the second priority by the severity of the alert, and determining a second priority order for making the status confirmation for each of the plurality of alerts in order from the alert for which the fourth priority is highest;
notifying the first handler of (i) the first priority order and (ii) the first item corresponding to an alert, among the plurality of alerts, that is highest in the first priority order; and
notifying the second handler of (i) the second priority order and (ii) the second item corresponding to an alert, among the plurality of alerts, that is highest in the second priority order.

11. The alert handling notification method according to claim 8,
wherein each of the plurality of confirmation information items further includes a third item associated with a third weight and indicating content of a third status confirmation to be made by the first handler, and a fourth item associated with a fourth weight and indicating content of a fourth status confirmation to be made by the second handler, and
the alert handling notification method further comprises,
when completion information indicating that one of the first status confirmation, the second status confirmation, the third status confirmation, or the fourth status confirmation is complete is received:
recalculating the first priority and the second priority using one or more weights among the first weight, the second weight, the third weight, and the fourth weight, excluding a weight associated with an item indicating content of a status confirmation indicated by the completion information as being complete.

12. The alert handling notification method according to claim 10,
wherein each of the plurality of confirmation information items further includes a third item associated with a third weight and indicating content of a third status confirmation made by the first handler, and a fourth item associated with a fourth weight and indicating content of a fourth status confirmation made by the second handler, and
the alert handling notification method further comprises,
when completion information indicating that one of the first status confirmation, the second status confirmation, the third status confirmation, or the fourth status confirmation is complete is received:
recalculating the first priority and the second priority using one or more weights resulting from excluding, from the first weight, the second weight, the third weight, and the fourth weight, a weight associated with an item indicating content of a status confirmation indicated by the completion information as being complete; and
recalculating the third priority and the fourth priority using the first priority and the second priority for the alert that have been recalculated.

13. A non-transitory computer-readable recording medium having recorded thereon a program for causing a computer to execute the alert handling notification method according to claim 1.

14. An alert handling notification device comprising:
a communicator that receives an alert indicating an anomaly that has occurred in an Operational Technology (OT) environment;
storage that stores a plurality of confirmation information items, each confirmation information item indicating content of a status confirmation for an alert of a type corresponding to the confirmation information item; and
a determiner that determines a handler, among a first handler and a second handler, to be preferentially caused to make a status confirmation for the alert received,
wherein each of the plurality of confirmation information items includes a first item associated with a first weight and indicating content of a first status confirmation made by the first handler, and a second item associated with a second weight and indicating content of a second status confirmation made by the second handler,
the determiner determines the handler using the first weight and the second weight specified based on the confirmation information item corresponding to the type of the alert received, and
the communicator notifies the first handler of the first item when the first handler is determined to be the handler, and notifies the second handler of the second item when the second handler is determined to be the handler.
